(19) United States
(12) Patent Application Publication
(10) Pub. No.: US 2014/0099529 A1
(43) Pub. Date: Apr. 10, 2014

(54) POWER STORAGE DEVICE

(71) Applicant: SEMICONDUCTOR ENERGY LABORATORY CO., LTD., Atsugi-shi (JP)

(72) Inventors: Jun ISHIKAWA, Atsugi (JP); Kyosuke ITO, Niiza (JP); Rie YOKOI, Atsugi (JP)

(73) Assignee: SEMICONDUCTOR ENERGY LABORATORY CO., LTD., Atsugi-shi (JP)

(21) Appl. No.: 14/042,855

(22) Filed: Oct. 1, 2013

(30) Foreign Application Priority Data
Oct. 5, 2012 (JP) 2012-223622

(51) Int. Cl. H01G 9/035; H01G 11/62; H01M 2/24

(52) U.S. Cl. CPC H01G 9/035; H01M 2/24; H01G 11/62
USPC 429/126; 361/502; 361/503; 361/504

(57) ABSTRACT

A power storage device with a higher degree of safety is provided. Further, a power storage device with improved cycle life is provided. In the power storage device, an ionic liquid as a solvent of an electrolyte solution, and an exterior body is covered with a conductive component so as to prevent direct contact between a positive electrode current collector and the exterior body. This suppresses elution of the positive electrode current collector due to contact between different kinds of metals and accordingly prevents a phenomenon in which the eluted metal of the positive electrode current collector is deposited on a negative electrode and the deposited metal comes in contact with a positive electrode. Thus, an internal short-circuit caused by the contact can be prevented.

### TECHNICAL FIELD

The present invention relates to power storage devices. Note that the power storage device indicates all elements and devices which have a function of storing electricity.

### BACKGROUND ART

A variety of power storage devices, for example, nonaqueous secondary batteries such as lithium-ion batteries (LIBs), lithium-ion capacitors (LICs), and air cells, have been actively developed in recent years. In particular, demand for lithium-ion secondary batteries with high output and high energy density has rapidly grown with the development of the semiconductor industry, for the uses of electric appliances, for example, portable information terminals such as mobile phones, smartphones, and laptop computers, portable music players, and digital cameras; medical equipment; and next-generation clean energy vehicles such as hybrid electric vehicles (HEVs), electric vehicles (EVs), and plug-in hybrid electric vehicles (PHEVs). The lithium-ion batteries are essential for today's information society as rechargeable energy supply sources.

In many of widely-used lithium-ion secondary batteries, a nonaqueous electrolyte (also referred to as a nonaqueous electrolyte solution or simply an electrolyte solution) is used; the nonaqueous electrolyte contains an organic solvent such as ethylene carbonate, propylene carbonate, fluorinated cyclic ester, fluorinated acyclic ester, fluorinated cyclic ether, or fluorinated acyclic ether, and a lithium salt containing lithium ions. Note that the fluorinated cyclic ester in this specification refers to a cyclic ester in which fluorine is substituted for hydrogen as in a cyclic ester having alkyl fluoride. Similarly, in the fluorinated acyclic ester, the fluorinated cyclic ether, or the fluorinated acyclic ether, fluorine is substituted for hydrogen.

However, the organic solvents has volatility and a low flash point; thus, when the organic solvent is used in a lithium-ion secondary battery, the internal temperature of the lithium secondary battery might increase owing to short-circuit, overcharging or the like, and the lithium-ion secondary battery would explode or catch fire. Some kinds of organic solvent generate a hydrofluoric acid by a hydrolysis reaction. Since this hydrofluoric acid corrodes metal, there has been a concern about the reliability of batteries.

In view of the above problems, the use of an ionic liquid which has non-volatility and non-flammability as a nonaqueous solvent for a nonaqueous electrolyte of a lithium-ion secondary battery has been proposed. Examples of such an ionic liquid are an ionic liquid containing an ethylmethylimidazolium (EMI) cation and an ionic liquid containing an N-methyl-N-propylpiperidinium (PP₁₃) cation (see Patent Document 1).

### REFERENCE

### Patent Document

[Patent Document 1] Japanese Published Patent Application No. 2003-331918

### DISCLOSURE OF INVENTION

In the cell structure of widely-used lithium-ion secondary batteries, it is preferable that an exterior body be formed using a stainless steel (SUS) or the like having adequate strength and oxidation resistance. However, if this SUS directly contacts with a positive electrode current collector formed using aluminum or the like in an ionic liquid that is a solvent of an electrolyte solution, elution of the positive electrode current collector occurs due to contact between different kinds of metals; thus, a problem of shortening cycle life of the battery arises.

In consideration of the above-described problems, an object of one embodiment of the present invention is to provide a power storage device with a higher degree of safety. Further, an object of one embodiment of the present invention is to provide a power storage device with improved cycle life.

In one embodiment of the present invention, to achieve the above-described objects, a power storage device using an ionic liquid as a solvent of an electrolyte solution is provided with a conductive component between an exterior body and a positive electrode current collector so as to prevent direct contact between the exterior body and the positive electrode current collector.

Specifically, one embodiment of the present invention is a power storage device which includes a positive electrode provided in an exterior body and a negative electrode provided in the exterior body and facing the positive electrode with an electrolyte solution interposed therebetween. In the power storage device, the electrolyte solution includes an ionic liquid as a solvent. Further, a protective component having conductivity is provided between the exterior body and a positive electrode current collector included in the positive electrode.

In the above-described structure, the protective component may include aluminum.

In the above-described structure, the exterior body may include iron or nickel.

In the above-described structure, the positive electrode current collector may include aluminum.

In the above-described structure, a cation in the ionic liquid may include any one of a heterocyclic cation, an aromatic cation, a quaternary ammonium cation, a quaternary sulfonium cation, a quaternary phosphonium cation, a tertiary sulfonium cation, an acyclic quaternary ammonium cation, and an acyclic quaternary phosphonium cation.

In the above-described structure, an anion in the ionic liquid may include any one of a monovalent amide anion, a monovalent methide anion, a fluorosulfonic acid anion (SO₃F⁻), a perfluoroalkyl sulfonic acid anion, tetrafluoroborate (BF₄⁻), perfluoroalkylborate, hexafluorophosphate (PF6⁻), and perfluoroalkylphosphate.

With one embodiment of the present invention, a power storage device with a high degree of safety can be provided. Further, a power storage device with improved cycle life can be provided.

### BRIEF DESCRIPTION OF DRAWINGS

In the accompanying drawings:

FIGS. 1A and 1B are an external view and a cross-sectional view of a coin-type power storage device;

FIGS. 2A to 2C illustrate a positive electrode;

FIGS. 3A to 3D illustrate a negative electrode;

FIGS. 4A and 4B illustrate a cylindrical power storage device;

FIG. 5 illustrates electric appliances;

FIGS. 6A to 6C illustrate an electric appliance;

FIG. 7 illustrates an electric appliance; and

FIG. 8 shows discharge characteristics of coin-type power storage devices.

### BEST MODE FOR CARRYING OUT THE INVENTION

Embodiments of the present invention will be described in detail below with reference to the accompanying drawings. Note that the present invention is not limited to the description below, and it is easily understood by those skilled in the art that a variety of changes and modifications can be made without departing from the spirit and scope of the present invention. Therefore, the present invention should not be interpreted as being limited to the description of the embodiments described below. In describing structures of the invention with reference to the drawings, the same reference numerals are used in common for the same portions in different drawings. The same hatching pattern is applied to similar parts, and the similar parts are not especially denoted by reference numerals in some cases. In addition, an insulating layer is not illustrated in a top view in some cases, for the sake of convenience. Note that the size, the layer thickness, or the region of each structure illustrated in each drawing is exaggerated for clarity in some cases and thus the actual scale is not necessarily limited to the illustrated scale.

### Embodiment 1

A structure of a power storage device of one embodiment of the present invention and a method for manufacturing the power storage device will be described with reference to drawings. An example in which the power storage device is a lithium-ion secondary battery will be described below.

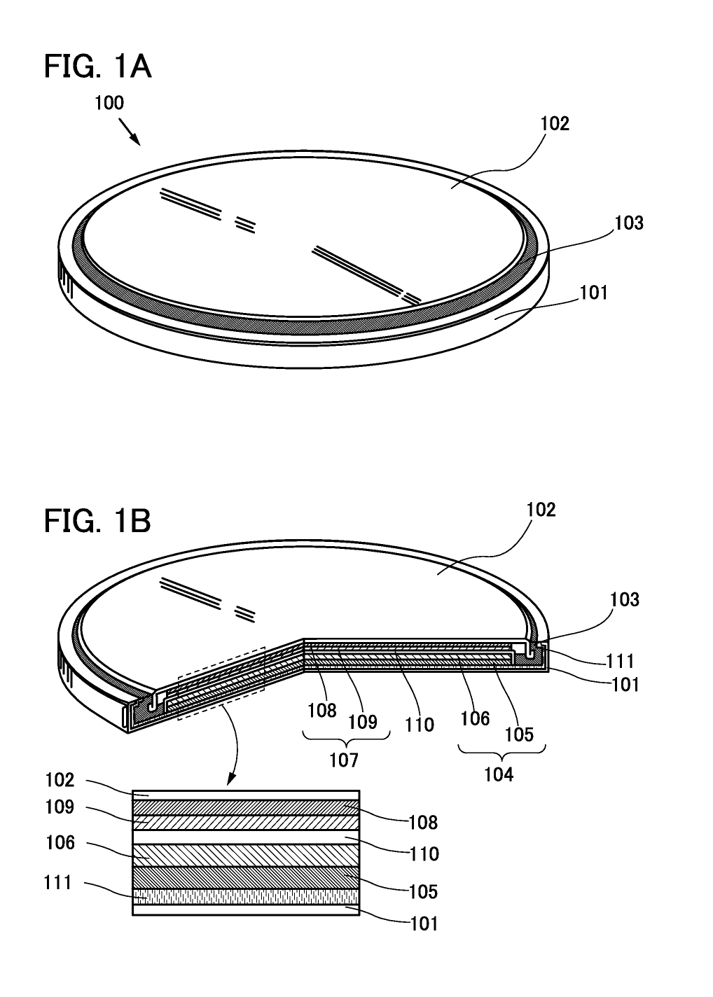

FIG. 1A is an external view of a coin-type power storage device 100, and FIG. 1B is a cross-sectional view thereof.

The coin-type power storage device 100 includes a positive electrode can 101 that is part of an exterior body and also serves as a positive electrode terminal, a negative electrode can 102 that is part of an exterior body and also serves as a negative electrode terminal, a gasket 103 formed using polypropylene or the like, a protective component 111 covering the positive electrode can 101, and an electrolyte solution (not illustrated) provided in a space surrounded by the positive electrode can 101 and the negative electrode can 102. Note that an ionic liquid is used as the electrolyte solution. In the power storage device 100, the positive electrode can 101 and the negative electrode can 102 are fixed with the gasket 103 interposed therebetween so as to be insulated from each other (see FIG. 1A).

Further, in the coin-type power storage device 100, a positive electrode 104 and a negative electrode 107 are provided so as to face each other with a separator 110 interposed therebetween. The positive electrode 104 includes a positive electrode current collector 105 in contact with the protective component 111, and a positive electrode active material layer 106 in contact with the positive electrode current collector 105. The negative electrode 107 includes a negative electrode current collector 108 in contact with the negative electrode can 102, and a negative electrode active material layer 109 in contact with the negative electrode current collector 108 (see FIG. 1B).

The use of one or more kinds of ionic liquids which are in a liquid state at normal temperature and pressure and have non-flammability and non-volatility as a solvent of the electrolyte solution can prevent the secondary battery from exploding or catching fire even when the internal temperature increases due to short-circuit, overcharging or the like. In this specification, normal temperature means a temperature in the range of higher than or equal to 5° C. and lower than or equal to 35° C.

An ionic liquid is a salt in the liquid state and has high ion mobility (conductivity). Further, the ionic liquid includes a cation and an anion. As the cation, a heterocyclic cation, an aromatic cation, a quaternary ammonium cation, a quaternary sulfonium cation, a quaternary phosphonium cation, a tertiary sulfonium cation, an acyclic quaternary ammonium cation, an acyclic quaternary phosphonium cation, an aromatic cation, or the like can be given. As the anion, a monovalent amide anion, a monovalent methide anion, a fluorosulfonic acid anion (SO₃F⁻), a perfluoroalkyl sulfonic acid anion, tetrafluoroborate (BF₄⁻), perfluoroalkylborate, hexafluorophosphate (PF6⁻), perfluoroalkylphosphate, or the like can be given. An example of the monovalent amide anion is (CₙF₂ₙ₊₁SO₂)₂N⁻ (n=0 to 3), and an example of the cyclic monovalent amide anion is CF₂(CF₂SO₂)₂N⁻. An example of the monovalent methide anion is (CₙF₂ₙ₊₁SO₂)₃C⁻ (n=0 to 3), and an example of the cyclic monovalent methide anion is CF₂(CF₂SO₂)₂C⁻(CF₃SO₂). An example of the perfluoroalkyl sulfonic acid anion is (CₘF₂ₘ₊₁SO₃)⁻ (m=0 to 4). An example of the perfluoroalkylborate is {BFₙ(CₘHₖF₂ₘ₊₁₋ₖ)₄₋ₙ}⁻ (n=0 to 3, m=1 to 4, and k=0 to 2m). An example of the perfluoroalkylphosphate is {PFₙ(CₘHₖF₂ₘ₊₁₋ₖ)₆₋ₙ}⁻ (n=0 to 5, m=1 to 4, and k=0 to 2m). Note that the anion is not limited to those mentioned here.

An ionic liquid represented by General Formula (G1) can be used.

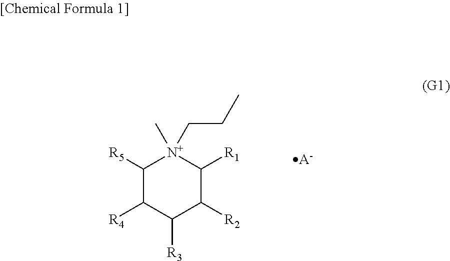

In General Formula (G1), R₁ to R₅ represent any of a hydrogen atom, an alkyl group having 1 to 20 carbon atoms, a methoxy group, a methoxymethyl group, and a methoxyethyl group. When one of R₁ to R₅ is any of an alkyl group having 1 to 20 carbon atoms, a methoxy group, a methoxymethyl group, and a methoxyethyl group, the other four of R₁ to R₅ are hydrogen atoms. When two of R₁ to R₅ are any of an alkyl group having 1 to 20 carbon atoms, a methoxy group, a methoxymethyl group, and a methoxyethyl group, the other three of R₁ to R₅ are hydrogen atoms. When three of R₁ to R₅ are any of an alkyl group having 1 to 20 carbon atoms, a methoxy group, a methoxymethyl group, and a methoxyethyl group, the other two of R₁ to R₅ are hydrogen atoms. When four of R₁ to R₅ are any of an alkyl group having 1 to 20 carbon atoms, a methoxy group, a methoxymethyl group, and a methoxyethyl group, the other one of R₁ to R₅ is a hydrogen atom. A⁻ may be a monovalent amide anion, a monovalent methide anion, a fluorosulfonic acid anion (SO₃F⁻), a perfluoroalkyl sulfonic acid anion, tetrafluoroborate (BF₄⁻), perfluoroalkylborate, hexafluorophosphate (PF6⁻), perfluoroalkylphosphate, or the like. An example of the monovalent amide anion is (CₙF₂ₙ₊₁SO₂)₂N⁻ (n=0 to 3), and an example of the cyclic monovalent amide anion is CF₂(CF₂SO₂)₂N⁻. An example of the monovalent methide anion is (CₙF₂ₙ₊₁SO₂)₃C⁻ (n=0 to 3), and an example of the cyclic monovalent methide anion is CF₂(CF₂SO₂)₂C⁻(CF₃SO₂). An example of the perfluoroalkyl sulfonic acid anion is (CₘF₂ₘ₊₁SO₃)⁻ (m=0 to 4). An example of the perfluoroalkylborate is {BFₙ(CₘHₖF₂ₘ₊₁₋ₖ)₄₋ₙ}⁻ (n=0 to 3, m=1 to 4, and k=0 to 2m). An example of the perfluoroalkylphosphate is {PFₙ(CₘHₖF₂ₘ₊₁₋ₖ)₆₋ₙ}⁻ (n=0 to 5, m=1 to 4, and k=0 to 2m). Note that the anion is not limited to those mentioned here.

Examples of General Formula (G1) with specific structures of the cation are Structural Formulae (100) to (116). Note that R₁ and R₅ in the cation of General Formula (G1) are symmetrical with respect to a line segment connecting N⁺ of piperidine and R₃. Similarly, R₂ and R₄ in the cation of General Formula (G1) are also symmetrical. For example, the cations with a methyl group at R₁ or R₂ are shown in Structural Formulae (101) and (102), and structural formulae that are equivalent to Structural Formulae (101) and (102) are not shown. In other words, the structural formula with a methyl group at R₅ instead of R₁ in Structural Formulae (101) and the structural formula with a methyl group at R₄ instead of R₂ in Structural Formulae (102) are equivalent to and have the same property as Structural Formulae (101) and (102), respectively, and are therefore omitted. The same applies to the other structural formulae shown below.

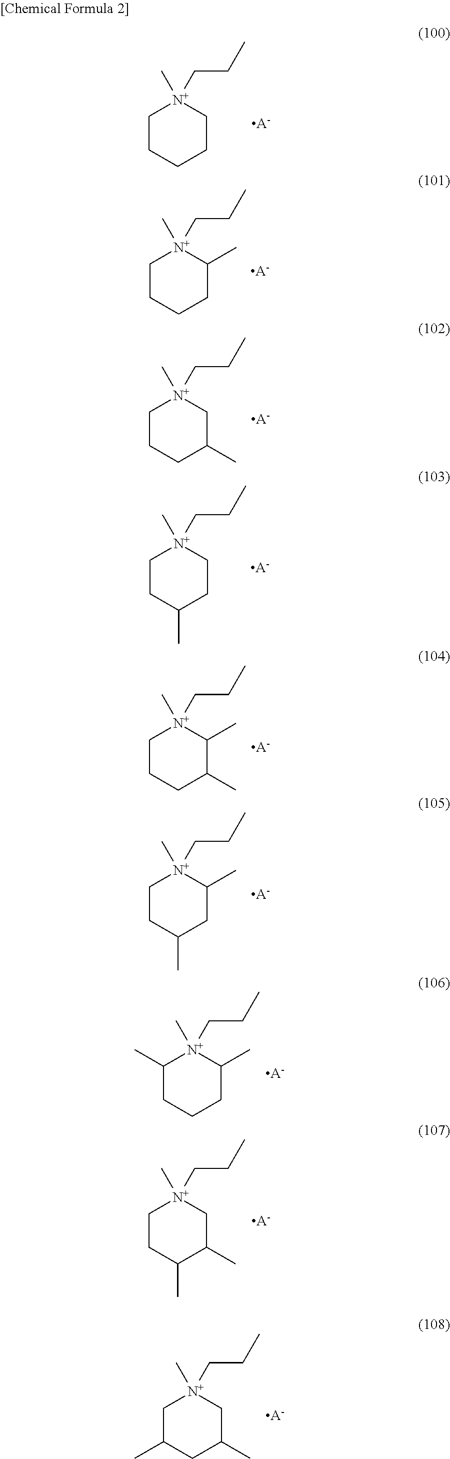

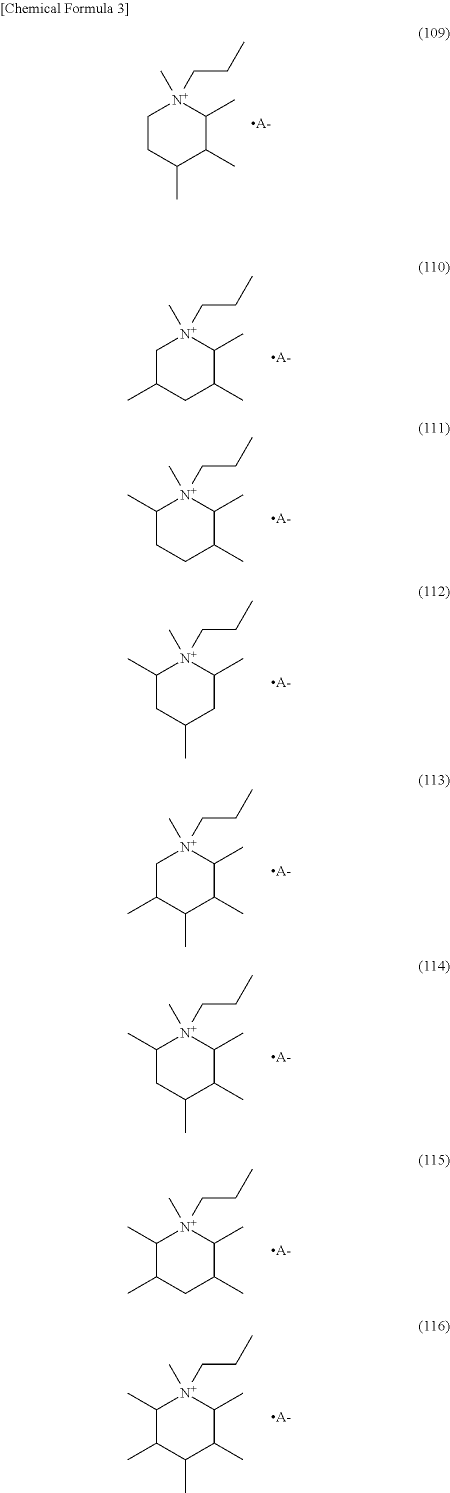

When including, for example, a chiral molecule (asymmetric molecule) such as the cations in Structural Formulae (101), (102), and (104), an ionic liquid is less stable and has a lower melting point; thus it is in a liquid state over a wider temperature range. Accordingly, a reduction in ionic conductivity can be prevented even in a low-temperature environment at lower than normal temperature, for example.

Further, by introducing a substituent having an electron donating property such as a methyl group or a methoxy group to a hetero cycle, the electron density of the hetero cycle decreases, the range of stable potential (also referred to as a potential window) can be widened, and strong reduction resistance can be obtained. For this reason, in such a case, cycle performance of secondary batteries can be improved. Note that the substituent having an electron donating property is more effective when being introduced at the ortho-position of the hetero cycle.

Further, an ionic liquid represented by General Formula (G2) can be used.

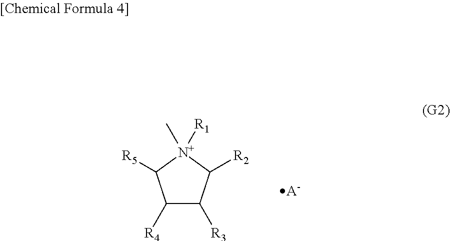

In General Formula (G2), R₁ represents an alkyl group having 1 to 4 carbon atoms. One or two of R₂ to R₅ represent any of an alkyl group having 1 to 20 carbon atoms, a methoxy group, a methoxymethyl group, and a methoxyethyl group, and the other three or two of R₂ to R₅ are hydrogen atoms. A⁻ may be a monovalent amide anion, a monovalent methide anion, a fluorosulfonic acid anion (SO₃F⁻), a perfluoroalkyl sulfonic acid anion, tetrafluoroborate (BF₄⁻), perfluoroalkylborate, hexafluorophosphate (PF6⁻), perfluoroalkylphosphate, or the like. An example of the monovalent amide anion is (CₙF₂ₙ₊₁SO₂)₂N⁻ (n=0 to 3), and an example of the cyclic monovalent amide anion is CF₂(CF₂SO₂)₂N⁻. An example of the monovalent methide anion is (CₙF₂ₙ₊₁SO₂)₃C⁻ (n=0 to 3), and an example of the cyclic monovalent methide anion is CF₂(CF₂SO₂)₂C⁻(CF₃SO₂). An example of the perfluoroalkyl sulfonic acid anion is (CₘF₂ₘ₊₁ SO₃)⁻ (m=0 to 4). An example of the perfluoroalkylborate is {BFₙ(CₘHₖF₂ₘ₊₁₋ₖ)₄₋ₙ}⁻ (n=0 to 3, m=1 to 4, and k=0 to 2m). An example of the perfluoroalkylphosphate is {PFₙ(CₘHₖF₂ₘ₊₁₋ₖ)₆₋ₙ}⁻ (n=0 to 5, m=1 to 4, and k=0 to 2m). Note that the anion is not limited to those mentioned here.

Examples of General Formula (G2) with specific structures of the cation are Structural Formulae (200) to (219). Note that R₂ and R₅ in the cation of General Formula (G2) are symmetrical with respect to a line segment connecting N⁺ of pyrrolidine and a midpoint between R₃ and R₄. Similarly, R₃ and R₄ in the cation of General Formula (G2) are also symmetrical. For example, the cations with a methyl group at R₂ to R₃ are shown in Structural Formulae (201) and (202), and structural formulae that are equivalent to Structural Formulae (201) and (202) are not shown. In other words, the structural formula with a methyl group at R₅ instead of R₂ in Structural Formulae (201) and the structural formula with a methyl group at R₄ instead of R₃ in Structural Formulae (202) are equivalent to and have the same property as Structural Formulae (201) and (202), respectively, and are therefore omitted. The same applies to the other structural formulae shown below.

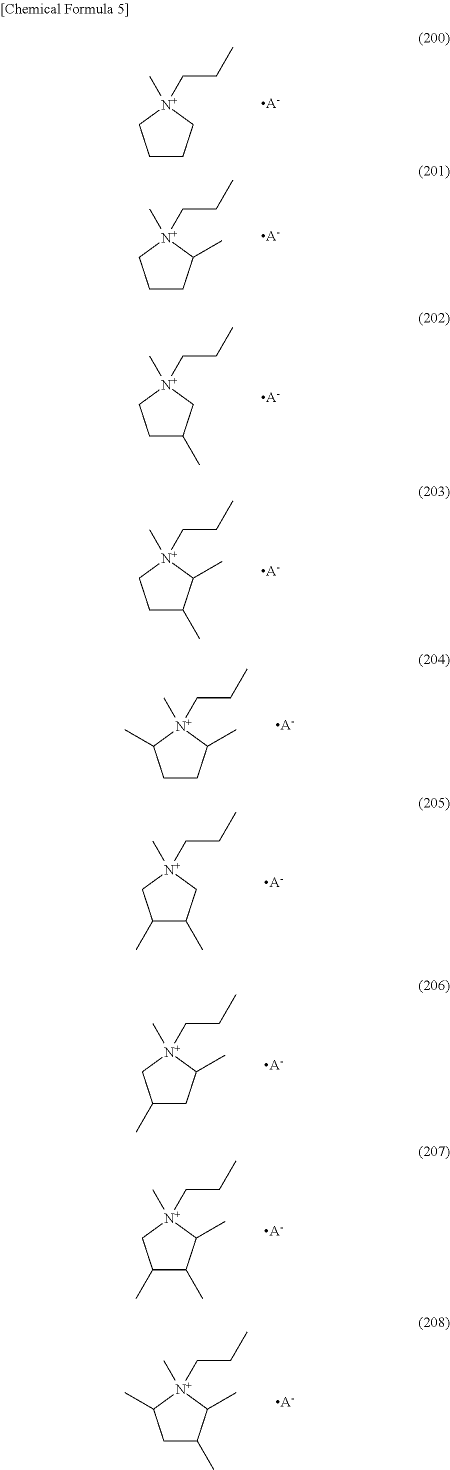

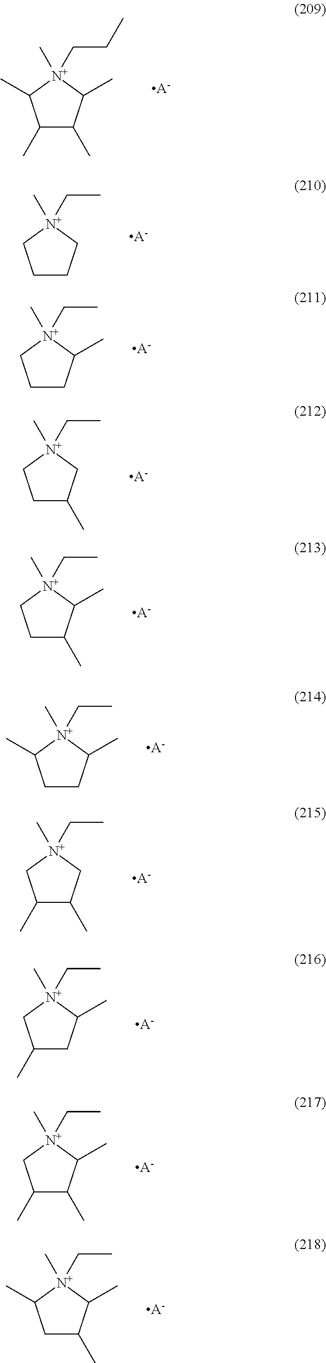

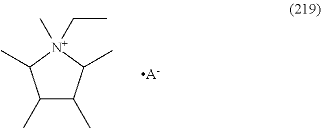

Further, a five-membered-ring ionic liquid as in General Formula (G2) has lower viscosity and thus has higher ionic conductivity than a six-membered-ring ionic liquid as in General Formula (G1).

Further, the ionic liquid may include a spiro ring. For example, an ionic liquid represented by General Formula (G3), which is a combination of five-membered rings, can be used.

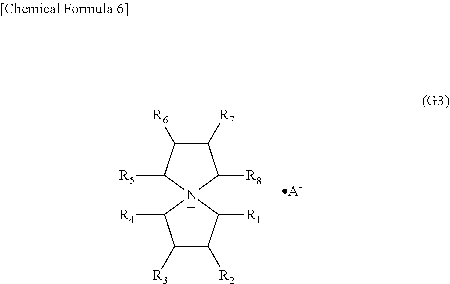

In General Formula (G3), R₁ to R₈ each represent a hydrogen atom, a straight-chain or branched-chain alkyl group having 1 to 4 carbon atoms, a straight-chain or branched-chain alkoxy group having 1 to 4 carbon atoms, or a straight-chain or branched-chain alkoxyalkyl group having 1 to 4 carbon atoms. A⁻ may be a monovalent amide anion, a monovalent methide anion, a fluorosulfonic acid anion (SO₃F⁻), a perfluoroalkyl sulfonic acid anion, tetrafluoroborate (BF₄⁻), perfluoroalkylborate, hexafluorophosphate (PF6⁻), perfluoroalkylphosphate, or the like. An example of the monovalent amide anion is (CₙF₂ₙ₊₁SO₂)₂N⁻ (n=0 to 3), and an example of the cyclic monovalent amide anion is CF₂(CF₂SO₂)₂N⁻. An example of the monovalent methide anion is (CₙF₂ₙ₊₁SO₂)₃C⁻ (n=0 to 3), and an example of the cyclic monovalent methide anion is CF₂(CF₂SO₂)₂C⁻(CF₃SO₂). An example of the perfluoroalkyl sulfonic acid anion is (CₘF₂ₘ₊₁SO₃)⁻ (m=0 to 4). An example of the perfluoroalkylborate is {BFₙ(CₘHₖF₂ₘ₊₁₋ₖ)₄₋ₙ}⁻ (n=0 to 3, m=1 to 4, and k=0 to 2m). An example of the perfluoroalkylphosphate is {PFₙ(CₘHₖF₂ₘ₊₁₋ₖ)₆₋ₙ}⁻ (n=0 to 5, m=1 to 4, and k=0 to 2m). Note that the anion is not limited to those mentioned here.

Alternatively, a spiro ring with a combination of a five-membered ring and a six-membered ring may be used. For example, an ionic liquid represented by General Formula (G4) can be used.

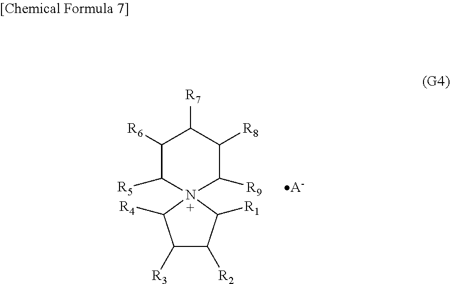

In General Formula (G4), R₁ to R₉ each represent a hydrogen atom, a straight-chain or branched-chain alkyl group having 1 to 4 carbon atoms, a straight-chain or branched-chain alkoxy group having 1 to 4 carbon atoms, or a straight-chain or branched-chain alkoxyalkyl group having 1 to 4 carbon atoms. A⁻ may be a monovalent amide anion, a monovalent methide anion, a fluorosulfonic acid anion (SO₃F⁻), a perfluoroalkyl sulfonic acid anion, tetrafluoroborate (BF₄⁻), perfluoroalkylborate, hexafluorophosphate (PF6⁻), perfluoroalkylphosphate, or the like. An example of the monovalent amide anion is (CₙF₂ₙ₊₁SO₂)₂N⁻ (n=0 to 3), and an example of the cyclic monovalent amide anion is CF₂(CF₂SO₂)₂N⁻. An example of the monovalent methide anion is (CₙF₂ₙ₊₁SO₂)₃C⁻ (n=0 to 3), and an example of the cyclic monovalent methide anion is CF₂(CF₂SO₂)₂C⁻(CF₃SO₂). An example of the perfluoroalkyl sulfonic acid anion is (CₘF₂ₘ₊₁SO₃)⁻ (m=0 to 4). An example of the perfluoroalkylborate is {BFₙ(CₘHₖF₂ₘ₊₁₋ₖ)₄₋ₙ}⁻ (n=0 to 3, m=1 to 4, and k=0 to 2m). An example of the perfluoroalkylphosphate is {PFₙ(CₘHₖF₂ₘ₊₁₋ₖ)₆₋ₙ}⁻ (n=0 to 5, m=1 to 4, and k=0 to 2m). Note that the anion is not limited to those mentioned here.

Other than the above-described spiro rings, a combination of a five-membered ring and a seven-membered ring, a combination of a six-membered ring and a seven-membered ring, a combination of seven-membered rings, or the like may also be used. Examples of General Formula (G3), General Formula (G4), the spiro ring with a combination of a five-membered ring and a seven-membered ring, the spiro ring with a combination of a six-membered ring and a seven-membered ring, and the spiro ring with a combination of seven-membered rings, which have specific structures of the cation, are Structural Formulae (300) to (497). In a manner similar to that of General Formula (G2), only one structural formula among those having the same property and being equivalent is illustrated to avoid overlaps.

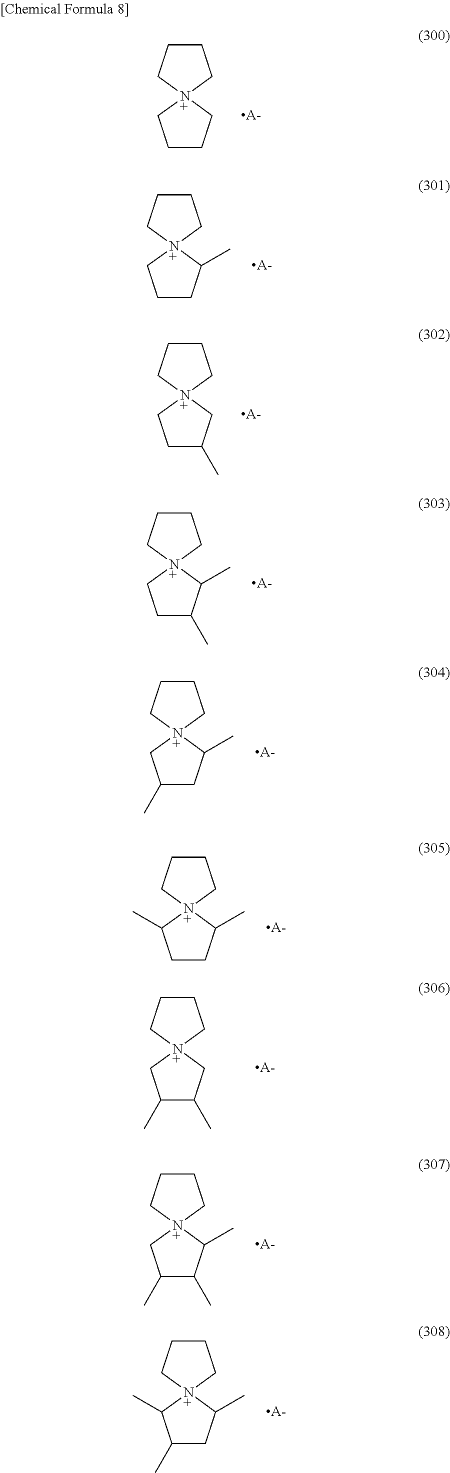

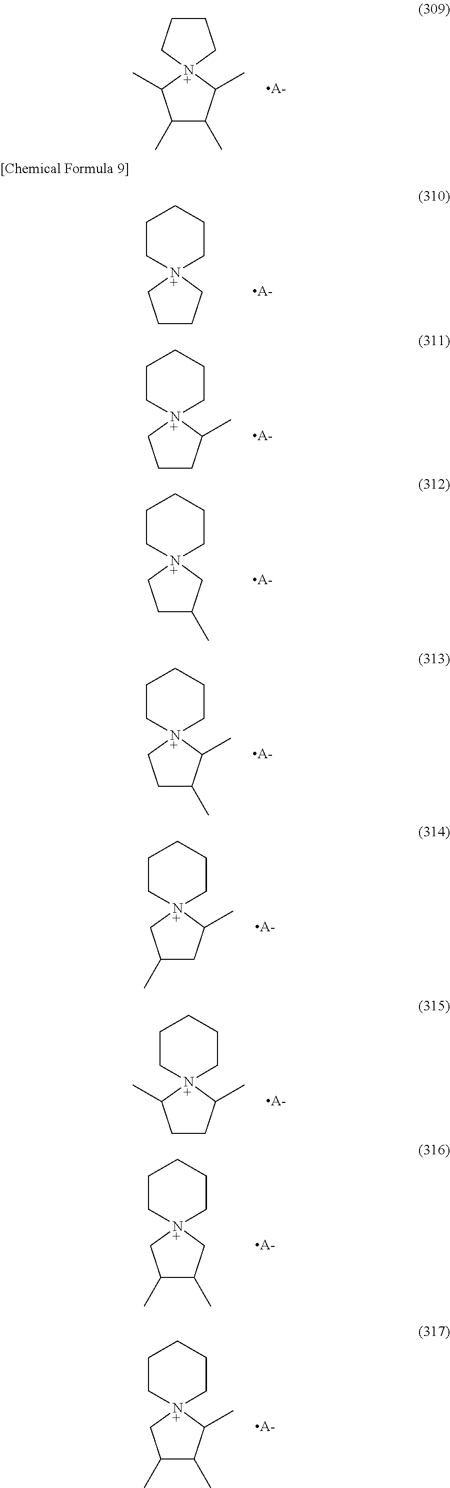

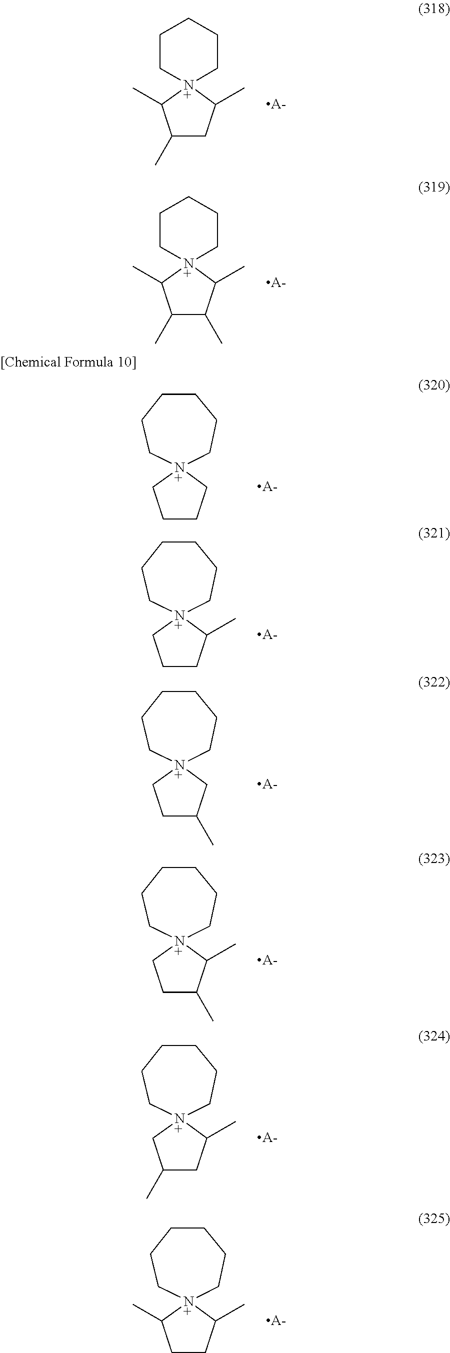

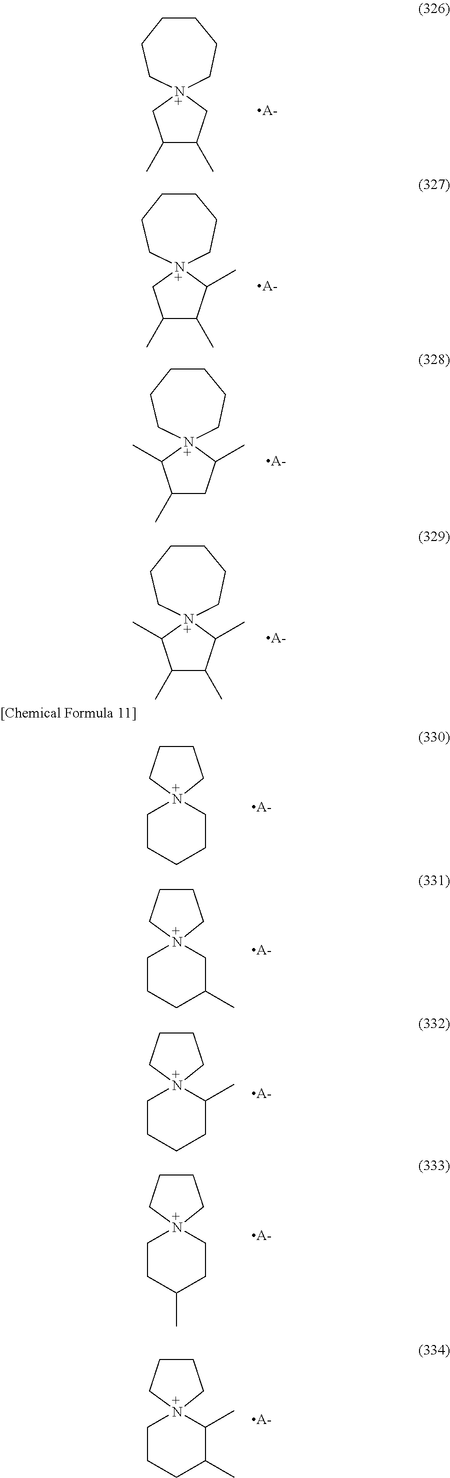

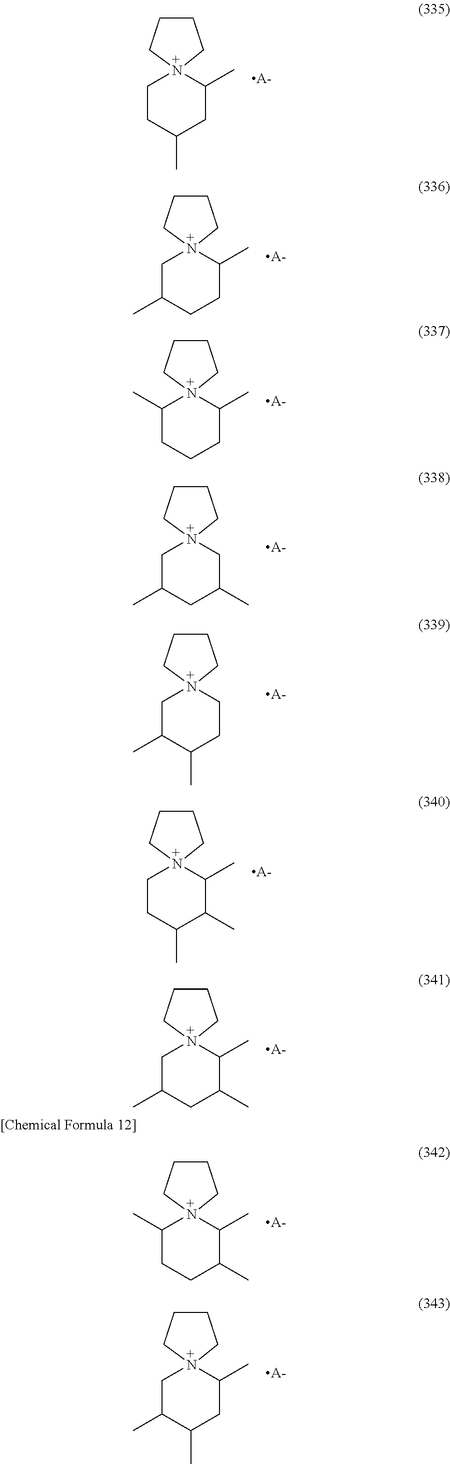

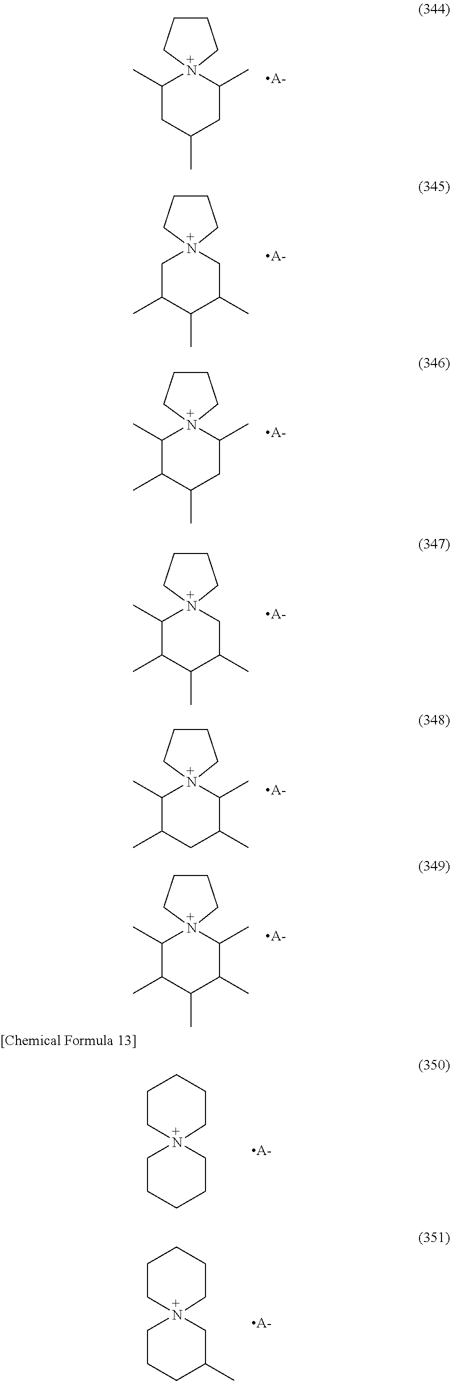

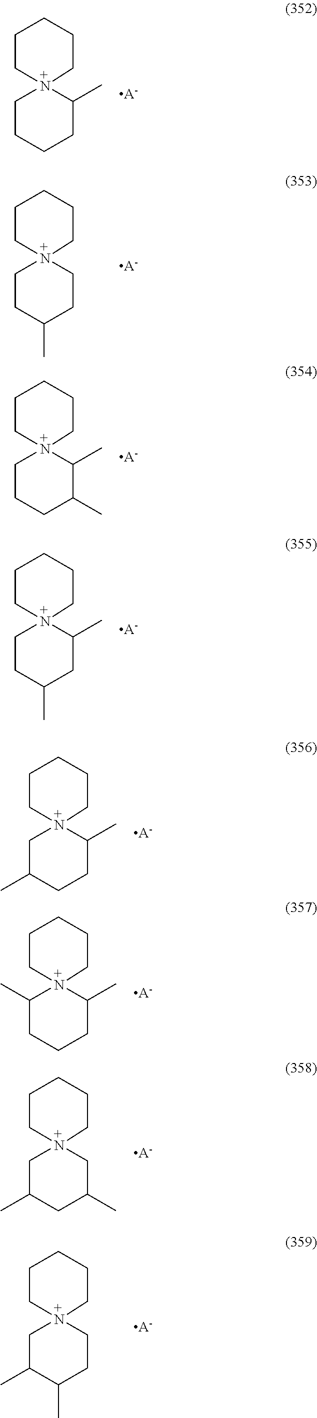

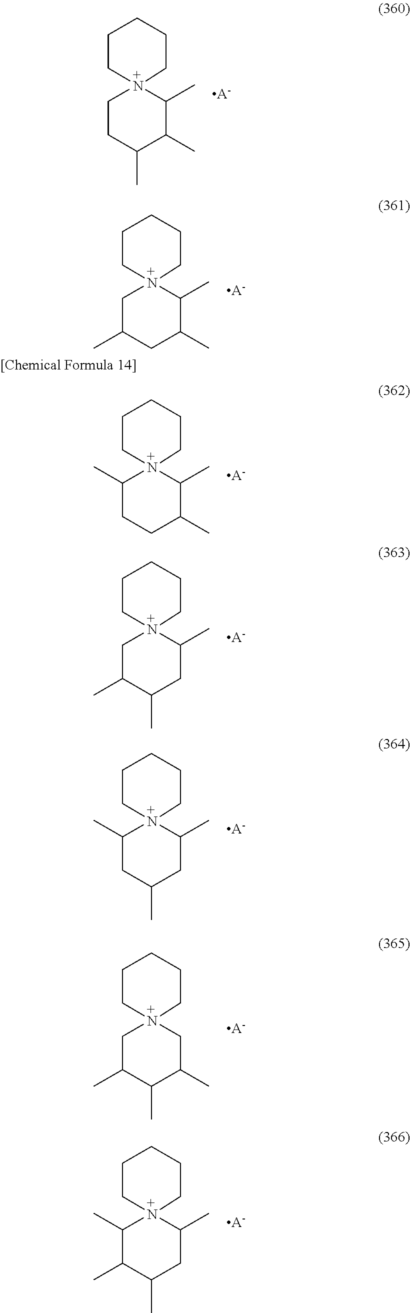

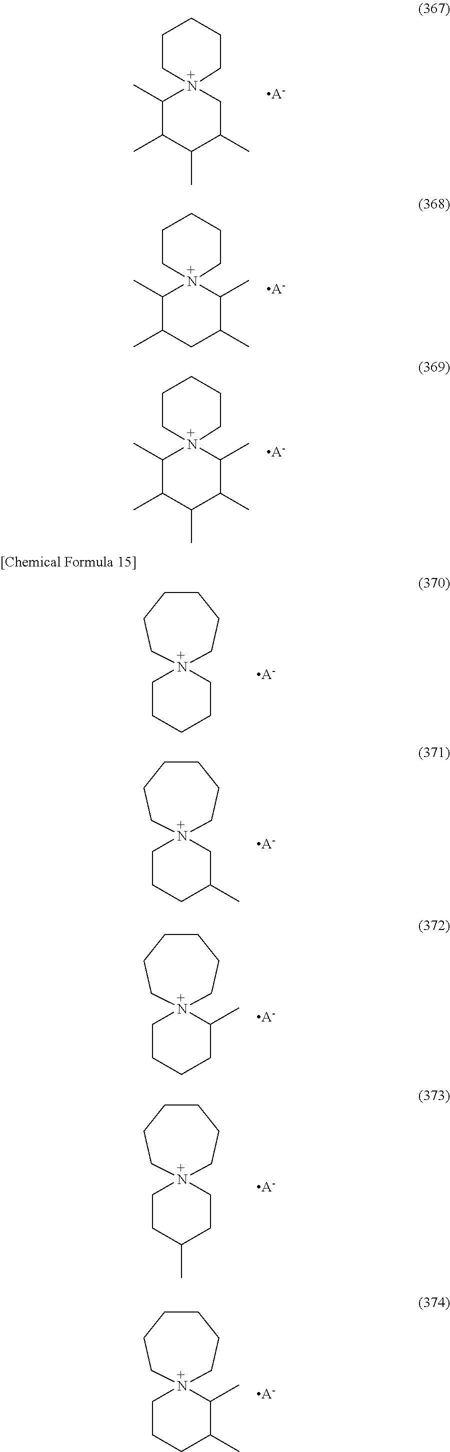

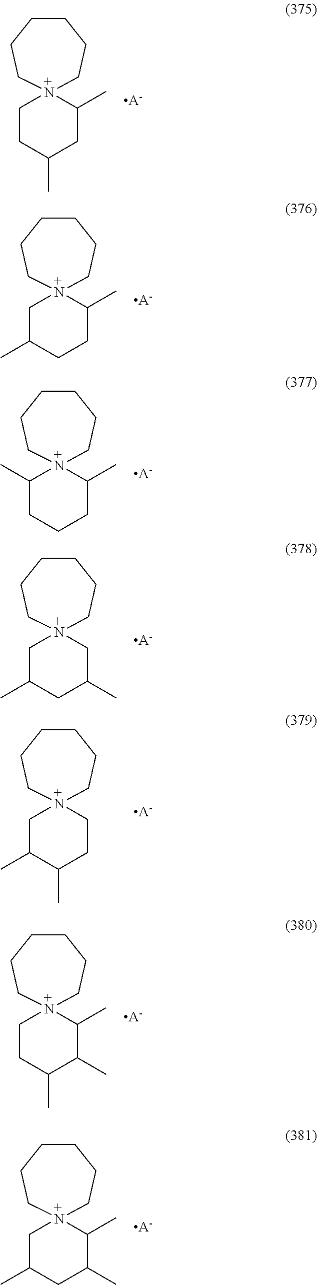

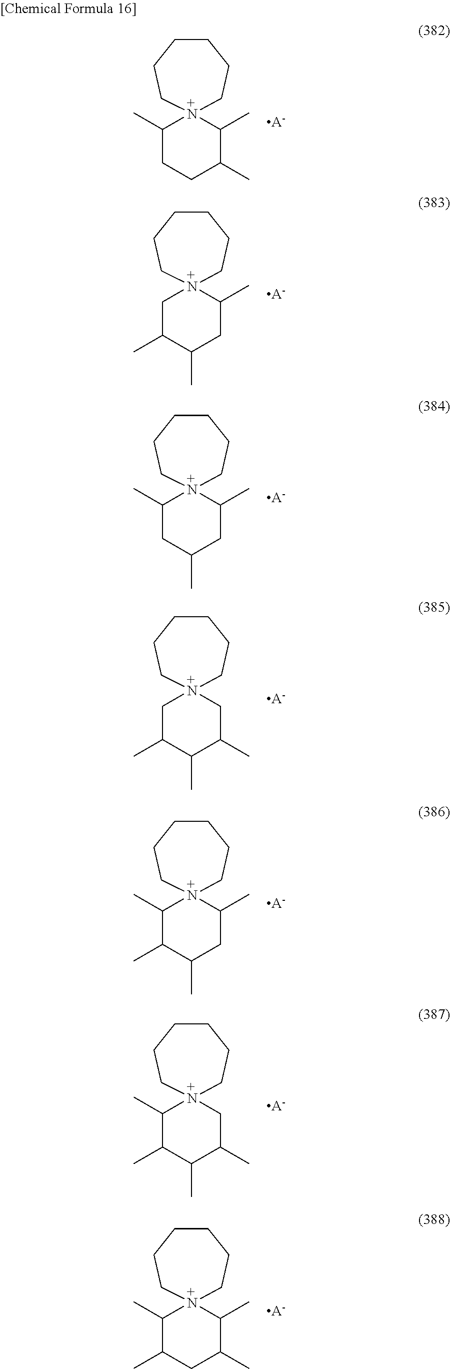

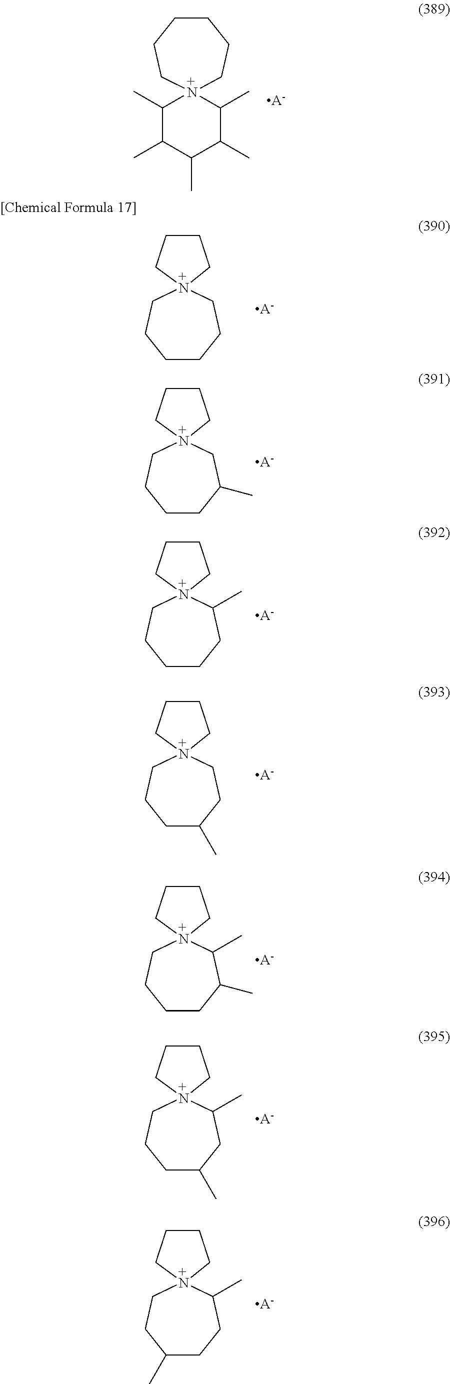

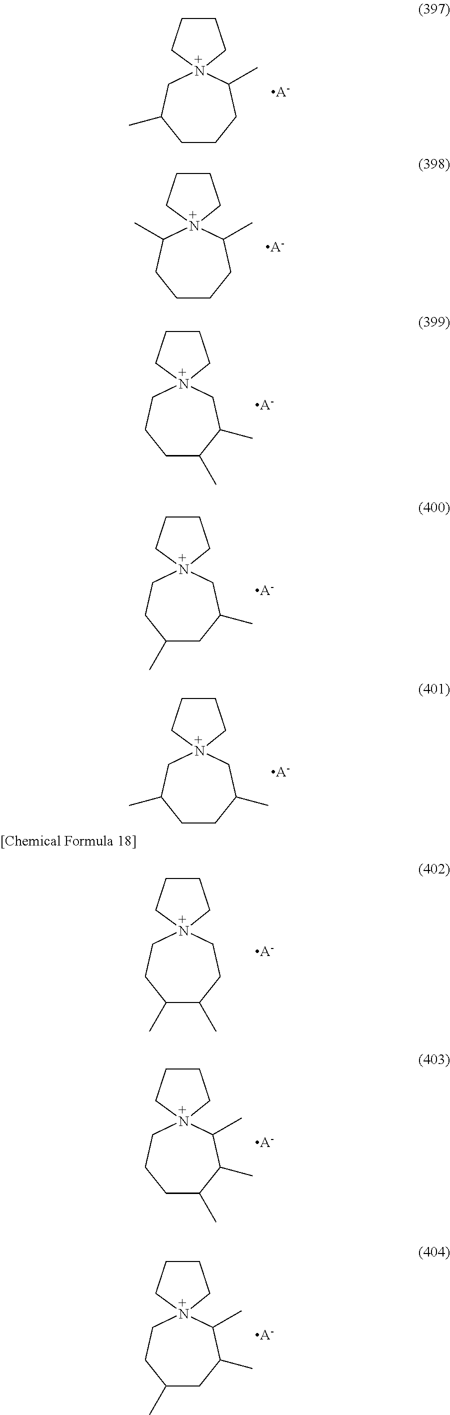

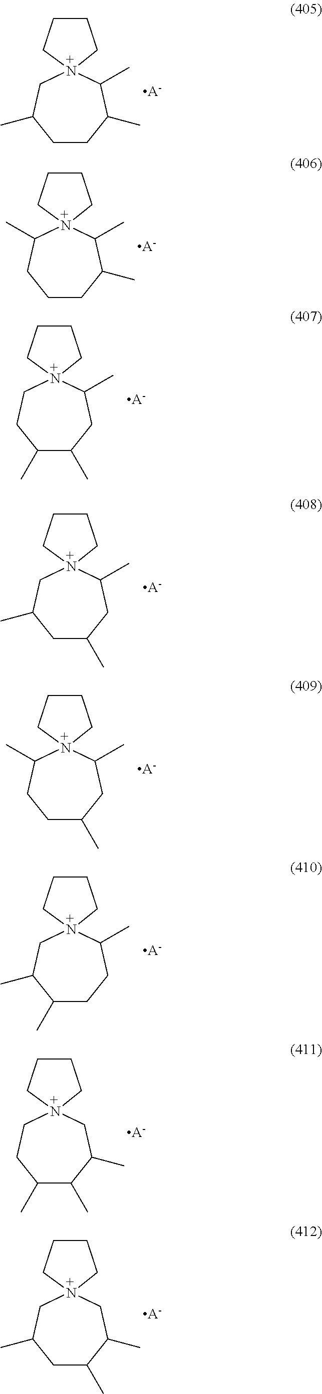

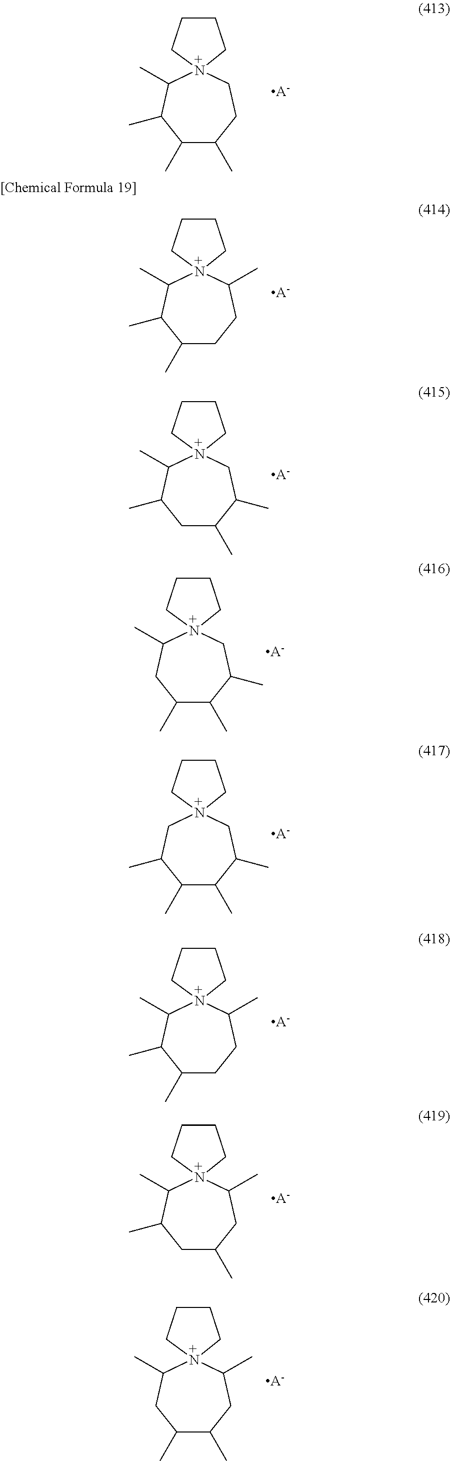

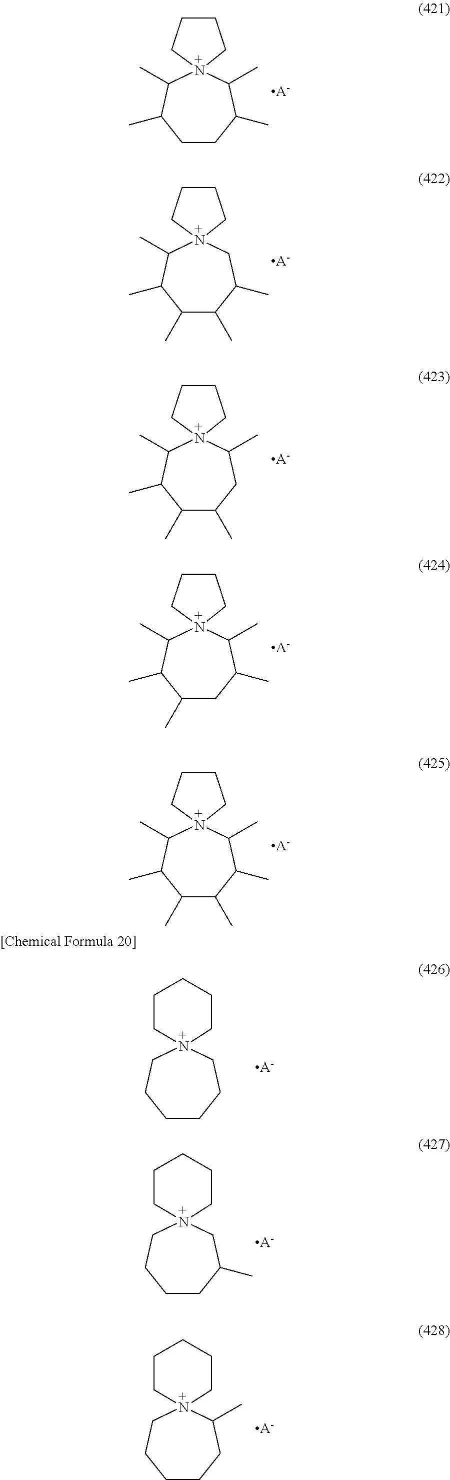

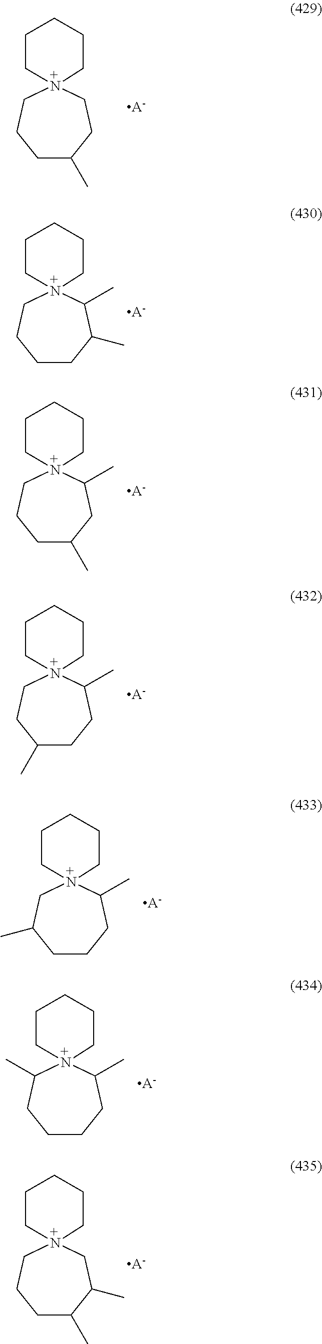

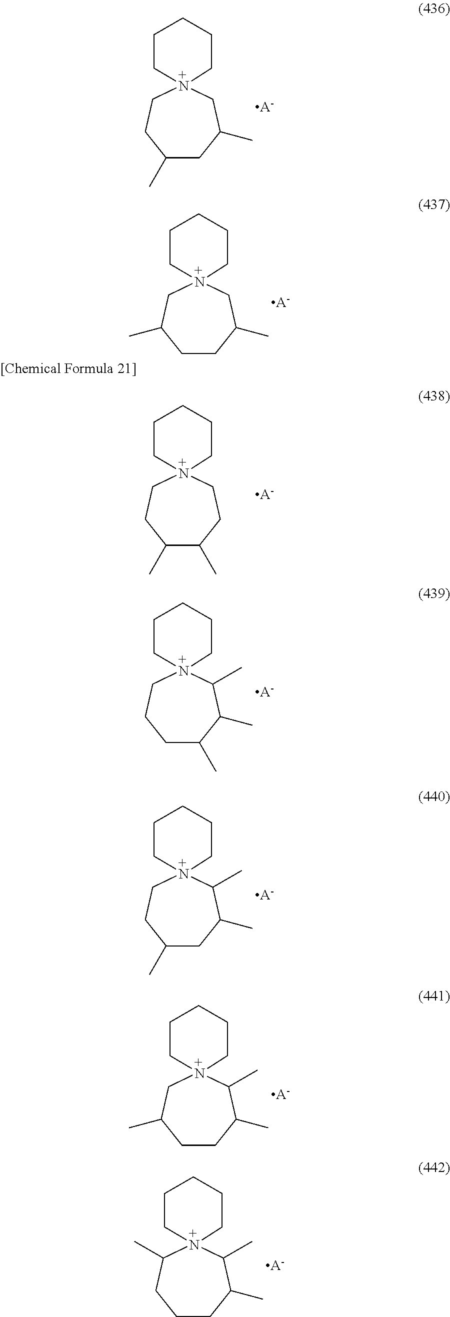

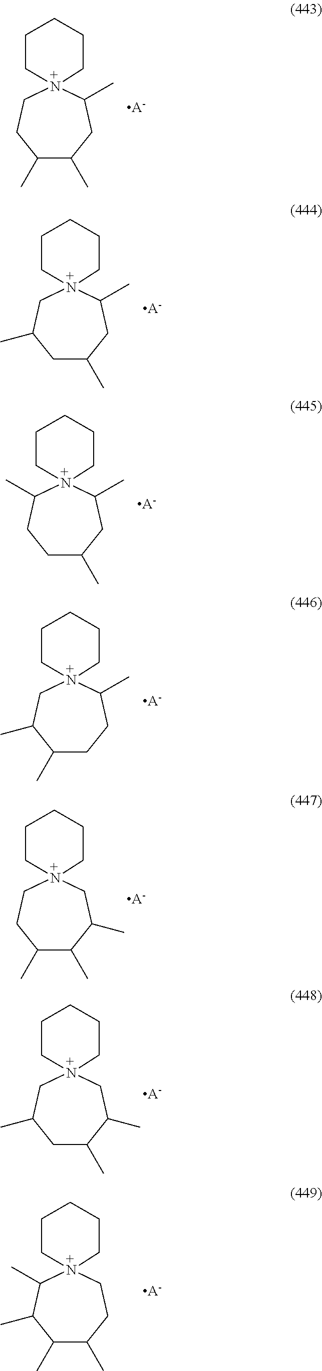

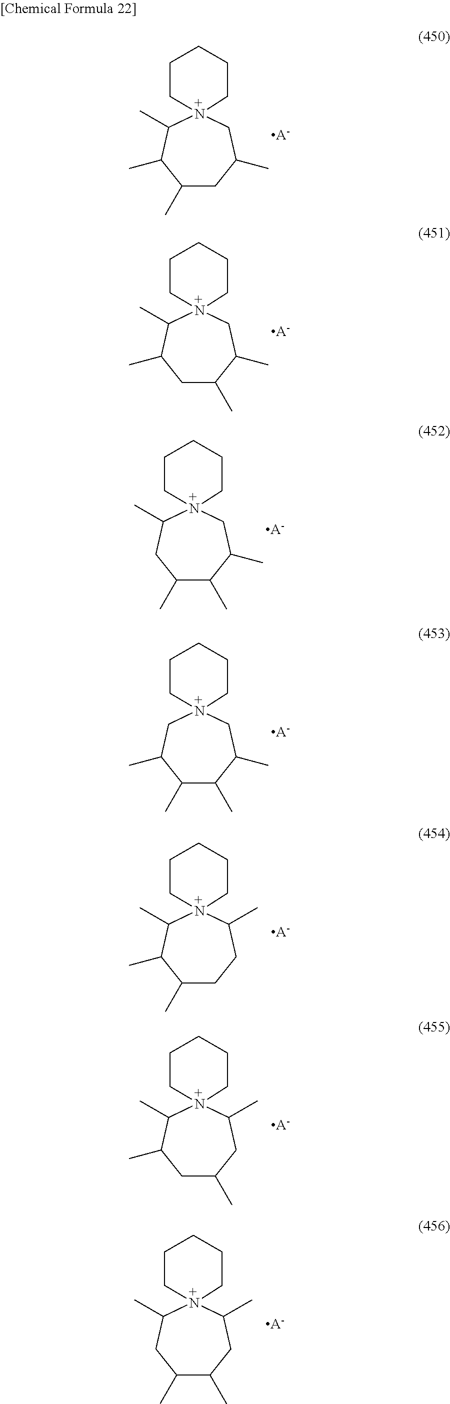

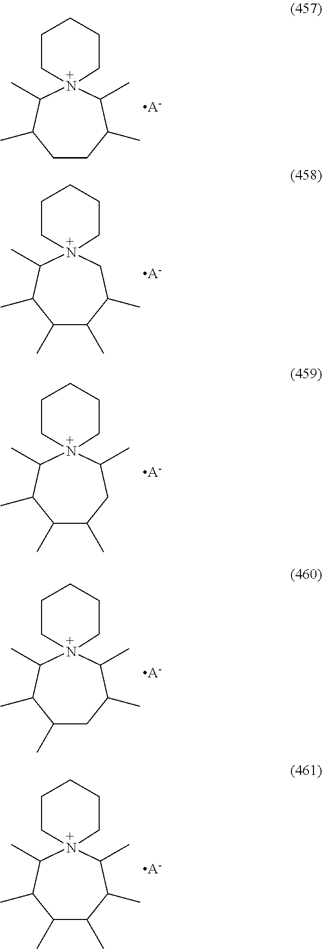

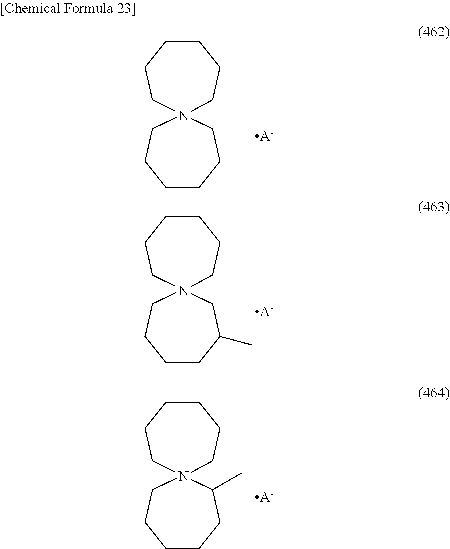

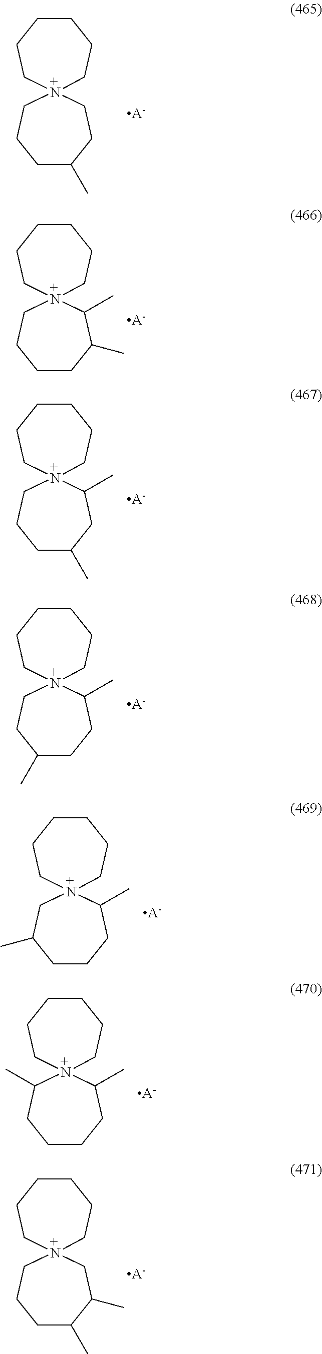

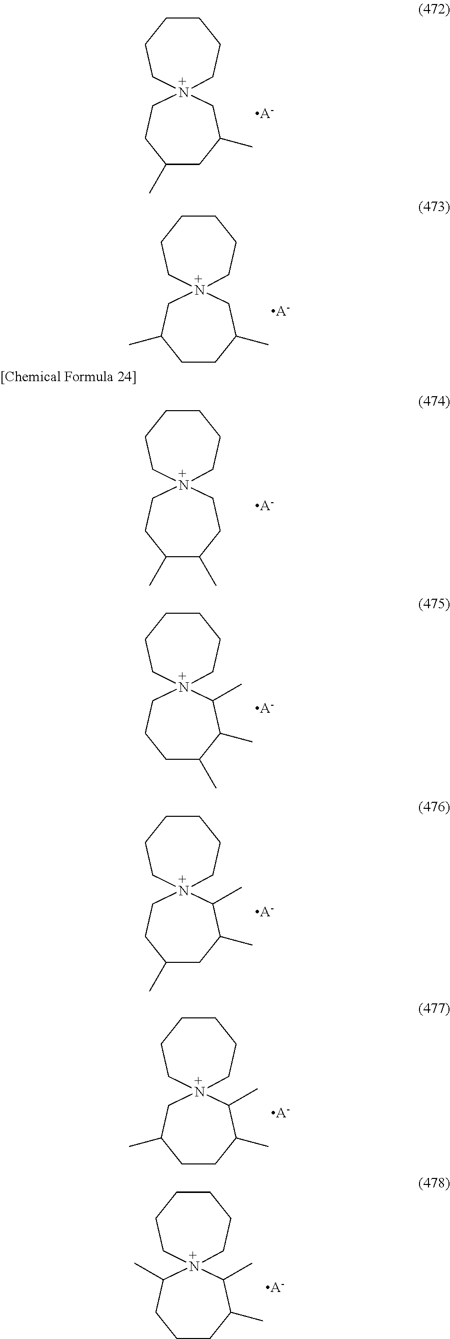

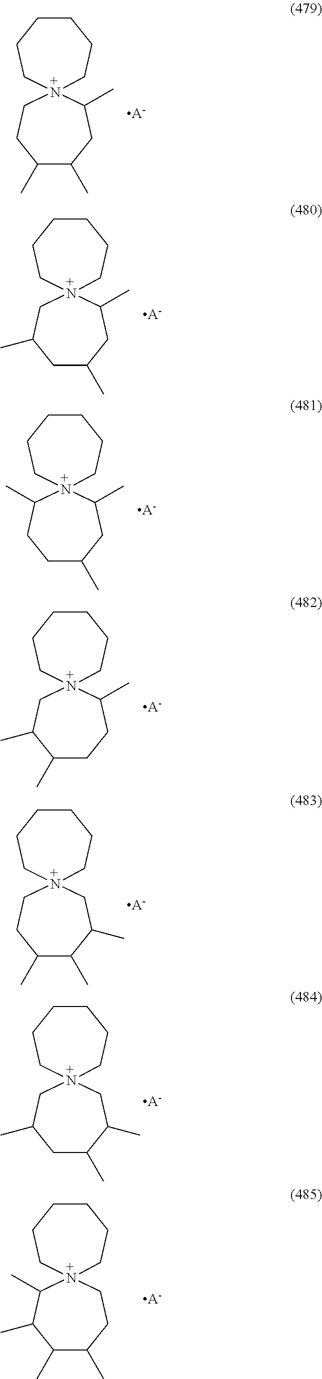

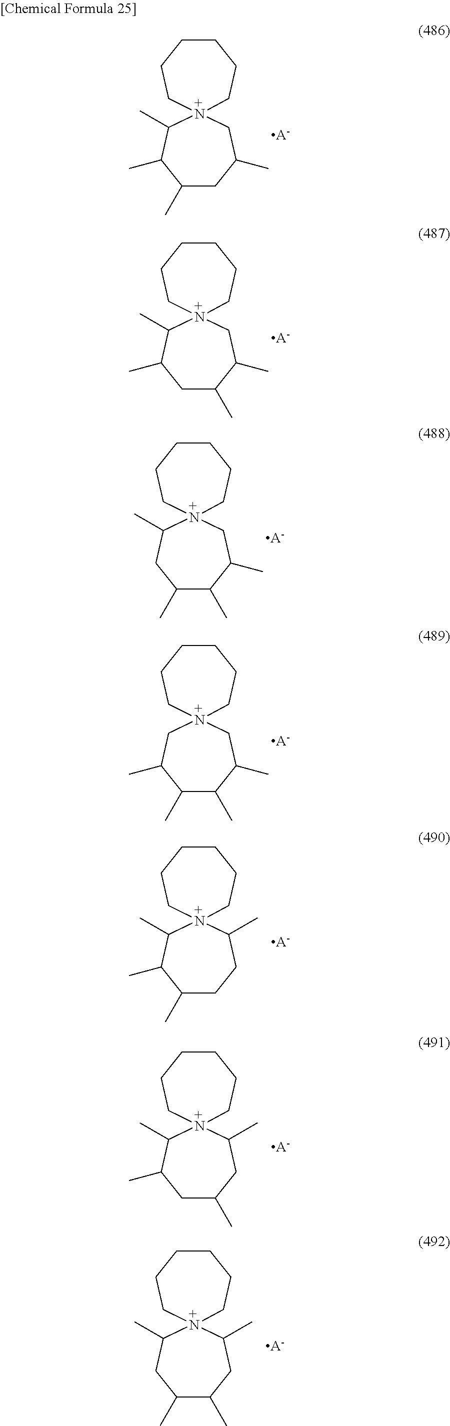

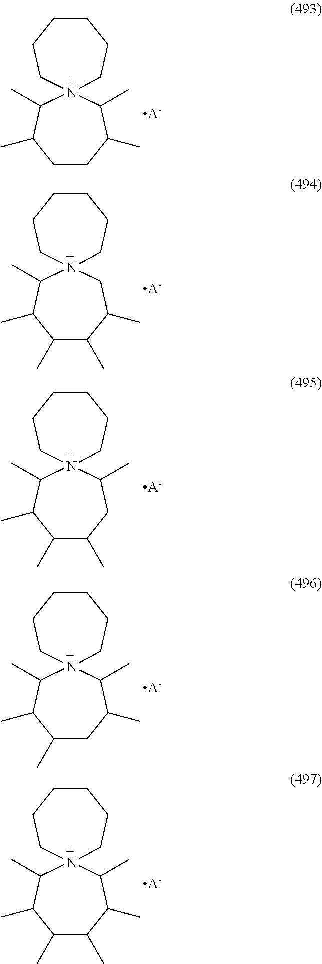

In Structural Formulae (300) to (497), A⁻ may be a monovalent amide anion, a monovalent methide anion, a fluorosulfonic acid anion (SO₃F⁻), a perfluoroalkyl sulfonic acid anion, tetrafluoroborate (BF₄⁻), perfluoroalkylborate, hexafluorophosphate (PF6⁻), perfluoroalkylphosphate, or the like. An example of the monovalent amide anion is (CₙF₂ₙ₊₁SO₂)₂N⁻ (n=0 to 3), and an example of the cyclic monovalent amide anion is CF₂(CF₂SO₂)₂N⁻. An example of the monovalent methide anion is (CₙF₂ₙ₊₁SO₂)₃C⁻ (n=0 to 3), and an example of the cyclic monovalent methide anion is CF₂(CF₂SO₂)₂C⁻(CF₃SO₂). An example of the perfluoroalkyl sulfonic acid anion is (CₘF₂ₘ₊₁SO₃)⁻ (m=0 to 4). An example of the perfluoroalkylborate is {BFₙ(CₘHₖF₂ₘ₊₁₋ₖ)₄₋ₙ}⁻ (n=0 to 3, m=1 to 4, and k=0 to 2m). An example of the perfluoroalkylphosphate is {PFₙ(CₘHₖF₂ₘ₊₁₋ₖ)₆₋ₙ}⁻ (n=0 to 5, m=1 to 4, and k=0 to 2m). Note that the anion is not limited to those mentioned here.

As an electrolyte dissolved in the above-described solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂)(CF₃SO₂), and LiN(C₂F₅SO₂)₂ can be used, or two or more of these lithium salts can be used in an appropriate combination in an appropriate ratio.

The protective component 111 is sandwiched between the positive electrode can 101 and the positive electrode current collector 105. The protective component 111 can be formed by vapor deposition on the positive electrode can 101 and can have a shape such as a thin film shape, a foil-like shape, or a plate-like shape (sheet-like shape).

For example, a method for covering the positive electrode can 101 with the protective component 111 is not particularly limited as long as the protective component 111 is in contact with the positive electrode can 101, and cladding can be used. Cladding is a method in which metals are bonded or attached by pressure.

In the case where the positive electrode can 101 is directly in contact with the positive electrode current collector 105 in an electrolyte solution using an ionic liquid, elution of the positive electrode current collector 105 arises due to contact between different kinds of metals, and the eluted metal of the positive electrode current collector 105 is deposited on the negative electrode 107. If the deposited metal comes in contact with the positive electrode 104, an internal short-circuit is caused and thus a rapid reduction in capacitance occurs, which shortens cycle life of the battery. In the case where the protective component 111 is provided between and in contact with the positive electrode can 101 and the positive electrode current collector 105, elution of the positive electrode current collector 105 can be prevented, which can improve cycle life.

The protective component 111 is electrically connected to the positive electrode can 101 and the positive electrode current collector 105. As the protective component 111, a conductive component excluding iron, nickel, and chromium may be used; for example, aluminum, carbon, platinum, a conductive polymer, or the like can be used. Since aluminum has a low density, it is preferable to use aluminum as the protective component 111 because the entire weight of the power storage device can be reduced.

As the separator 110, paper; nonwoven fabric; glass fiber; synthetic fiber such as nylon (polyamide), vinylon (polyvinyl alcohol-based fiber), polyester, acrylic, polyolefin, or polyurethane; or the like may be used. Note that a material which does not dissolve in the electrolyte solution should be selected.

More specifically, examples of the material of the separator 110 include fluorine-based polymers, polyethers such as a polyethylene oxide and a polypropylene oxide, polyolefins such as polyethylene and polypropylene, polyacrylonitrile, polyvinylidene chloride, polymethyl methacrylate, polymethylacrylate, polyvinyl alcohol, polymethacrylonitrile, polyvinyl acetate, polyvinylpyrrolidone, polyethyleneimine, polybutadiene, polystyrene, polyisoprene, and polyurethane based polymers, and derivatives thereof, cellulose, paper, nonwoven fabric, and glass fiber. One of the above materials or a combination of two or more of the above materials can be used for the separator 110.

As a material of the positive electrode can 101 and a material of the negative electrode can 102, a metal such as stainless steel containing iron, nickel, and chromium; iron; nickel; aluminum; or titanium can be used. The stainless steel and iron are particularly preferable because of high strength. The stainless steel and nickel are preferable because of high resistance to corrosion. To prevent corrosion which is caused by charge and discharge of the power storage device 100 due to the nonaqueous solvent in the electrolyte solution, it is particularly preferable to apply a coating of a corrosion-resistant metal such as nickel. The positive electrode can 101 and the negative electrode can 102 are electrically connected to the positive electrode 104 and the negative electrode 107, respectively.

Next, a structure of the positive electrode 104 is described.

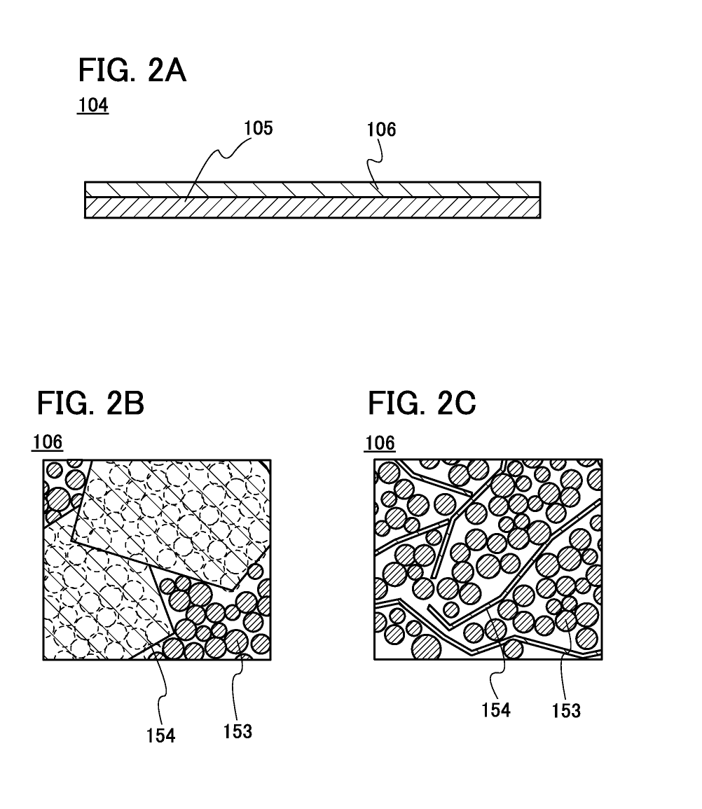

FIG. 2A is a cross-sectional view of the positive electrode 104. In the positive electrode 104, the positive electrode active material layer 106 is formed over the positive electrode current collector 105.

The positive electrode current collector 105 can be formed using a material having high conductivity such as a metal like stainless steel, gold, platinum, zinc, iron, copper, aluminum, or titanium, or an alloy thereof. Note that the positive electrode current collector 105 can be formed using an aluminum alloy to which an element which improves heat resistance, such as silicon, titanium, neodymium, scandium, or molybdenum, is added. Further alternatively, the positive electrode current collector 105 may be formed using a metal element which forms silicide by reacting with silicon. Examples of the metal element which forms silicide by reacting with silicon include zirconium, titanium, hafnium, vanadium, niobium, tantalum, chromium, molybdenum, tungsten, cobalt, nickel, and the like. The positive electrode current collector 105 can have a foil-like shape, a plate-like shape (sheet-like shape), a net-like shape, a punching-metal shape, an expanded-metal shape, or the like as appropriate.

The positive electrode active material layer 106 may include, in addition to a positive electrode active material, a conductive additive and a binder.

As the positive electrode active material of the positive electrode active material layer 106, a compound such as LiFeO₂, LiCoO₂, LiNiO₂, LiMn₂O₄, V₂O₅, Cr₂O₅, or MnO₂ can be used.

Alternatively, an olivine-type lithium-containing composite salt (General Formula: LiMPO₄ (M is one or more of Fe(II), Mn(II), Co(II), and Ni(II))) can be used. Typical examples of General Formula LiMPO₄ which can be used as an active material are lithium compounds such as LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐCo_{b}PO₄, LiNiₐMn_{b}PO₄ (a+b≦1, 0<a<1, and 0<b<1), LiFe_{c}Ni_{d}CoₑPO₄, LiFe_{c}Ni_{d}MnₑPO₄, LiNi_{c}Co_{d}MnₑPO₄ (c+d+e≦1, 0<c<1, 0<d<1, and 0<e<1), and LiFe_{f}Ni_{g}CoₕMnᵢPO₄ (f+g+h+i≦1, 0<f<1, 0<g<1, 0<h<1, and 0<i<1).

Alternatively, a lithium-containing composite salt such as one represented by General Formula Li₂MSiO₄ (M is one or more of Fe(II), Mn(II), Co(II), and Ni(II)) can be used. Typical examples of General Formula Li₂MSiO₄ which can be used as the material are lithium compounds such as Li₂FeSiO₄, Li₂NiSiO₄, Li₂CoSiO₄, Li₂MnSiO₄, Li₂FeₖNiₗSiO₄, Li₂FeₖCoₗSiO₄, Li₂FeₖMnₗSiO₄, Li₂NiₖCoₗSiO₄, Li₂NiₖMnₗSiO₄ (k+l≦1, 0<k<1, and 0<l<1), Li₂FeₘNiₙCo_{q}SiO₄, Li₂FeₘNiₙMn_{q}SiO₄, Li₂NiₘCoₙMn_{q}SiO₄ (m+n+q≦1, 0<m<1, 0<n<1, and 0<q<1), and Li₂FeᵣNiₛCoₜMnᵤSiO₄ (r+s+t+u≦1, 0<r<1, 0<s<1, 0<t<1, and 0<u<1).

In the case where carrier ions are alkali metal ions other than lithium ions or alkaline-earth metal ions, the positive electrode active material layer 106 may contain, instead of lithium in the lithium compound and the lithium-containing composite salt, an alkali metal (e.g., sodium or potassium), an alkaline-earth metal (e.g., calcium, strontium, barium, beryllium, or magnesium).

The positive electrode active material layer 106 is not necessarily formed over and in direct contact with the positive electrode current collector 105. Between the positive electrode current collector 105 and the positive electrode active material layer 106, any of the following functional layers may be formed using a conductive material such as a metal: an adhesive layer for the purpose of improving adhesiveness between the positive electrode current collector 105 and the positive electrode active material layer 106, a planarization layer for reducing unevenness of the surface of the positive electrode current collector 105, a heat radiation layer for radiating heat, and a stress relaxation layer for relieving stress of the positive electrode current collector 105 or the positive electrode active material layer 106.

FIG. 2B is a plan view of the positive electrode active material layer 106. As the positive electrode active material layer 106, a particulate positive electrode active material 153 that can occlude and release carrier ions is used. Further, FIG. 2B illustrates an example in which graphenes 154 cover a plurality of particles of the positive electrode active material 153 and surround a plurality of particles of the positive electrode active material 153. The plurality of graphenes 154 cover surfaces of the plurality of particles of the positive electrode active material 153. The positive electrode active material 153 may be partly exposed.

The size of each particle of the positive electrode active material 153 is preferably greater than or equal to 20 nm and less than or equal to 100 nm. Note that the size of the particle of the positive electrode active material 153 is preferably as small as possible because electrons transfer in the positive electrode active material 153.

Although sufficient characteristics can be obtained even when the surface of the positive electrode active material 153 is not covered with a graphite layer, graphene and a positive electrode active material covered with a graphite layer are preferably used in combination, in which case hopping of carrier ions occurs between particles of the positive electrode active material, so that current flows.

FIG. 2C is a cross-sectional view of part of the positive electrode active material layer 106 in FIG. 2B. The positive electrode active material layer 106 includes the particles of the positive electrode active material 153 and the graphenes 154 covering a plurality of particles of the positive electrode active material 153. The graphene 154 has a linear shape when observed in the cross-sectional view. A plurality of particles of the positive electrode active material is provided between parts of one graphene or a plurality of graphenes. Note that the graphene has a bag-like shape and the plurality of particles of the positive electrode active material exists in the bag-like portion in some cases. In addition, the particles of the positive electrode active material are partly not covered with the graphenes and exposed in some cases.

The desired thickness of the positive electrode active material layer 106 is determined in the range of 20 μm to 100 μm. It is preferable to adjust the thickness of the positive electrode active material layer 106 as appropriate so that cracks and separation do not occur.

Note that the positive electrode active material layer 106 may contain a known conductive additive, for example, acetylene black particles having a volume 0.1 to 10 times as large as that of the graphenes or carbon particles such as carbon nanofibers having a one-dimensional expansion.

As an example of a material of the positive electrode active material, there is a material whose volume is increased by occlusion of ions serving as carriers. When such a material is used, the positive electrode active material layer gets friable and is partly broken due to charge and discharge, which results in lower reliability of the power storage device. However, even when the volume of the positive electrode active material is increased due to charge and discharge, the graphenes can prevent dispersion of the particles of the positive electrode active material and the breakdown of the positive electrode active material layer because the graphenes cover the periphery of the positive electrode active material. That is to say, the graphenes have a function of maintaining the bond between the particles of the positive electrode active material even when the volume of the positive electrode active material fluctuates due to charge and discharge.

The graphenes 154 are in contact with the plurality of particles of the positive electrode active material and serve also as a conductive additive. Further, the graphenes have a function of holding the positive electrode active material capable of occluding and releasing carrier ions. Thus, a binder does not have to be mixed into the positive electrode active material layer. Accordingly, the amount of the positive electrode active material in the positive electrode active material layer can be increased, which allows an increase in discharge capacity of the nonaqueous secondary battery.

Next, a method for forming the positive electrode active material layer 106 is described.

First, a slurry containing the particles of the positive electrode active material and graphene oxide is formed. Next, the slurry is applied onto the positive electrode current collector 105. Then, heating is performed in a reduced atmosphere for reduction treatment so that the positive electrode active material is baked and oxygen included in the graphene oxide is eliminated to form graphene. Note that oxygen in the graphene oxide is not entirely released and partly remains in the graphene. Through the above steps, the positive electrode active material layer 106 can be formed over the positive electrode current collector 105. Consequently, the positive electrode active material layer 106 has high conductivity.

Graphene oxide contains oxygen and thus is negatively charged in a polar solvent. As a result of being negatively charged, graphene oxide is dispersed in the polar solvent. Therefore, the particles of the positive electrode active material contained in the slurry are not easily aggregated, so that an increase in the size of the particles of the positive electrode active material due to aggregation can be prevented. Thus, the transfer of electrons in the positive electrode active material is facilitated, resulting in an increase in conductivity of the positive electrode active material layer.

Next, a structure of the negative electrode 107 is described.

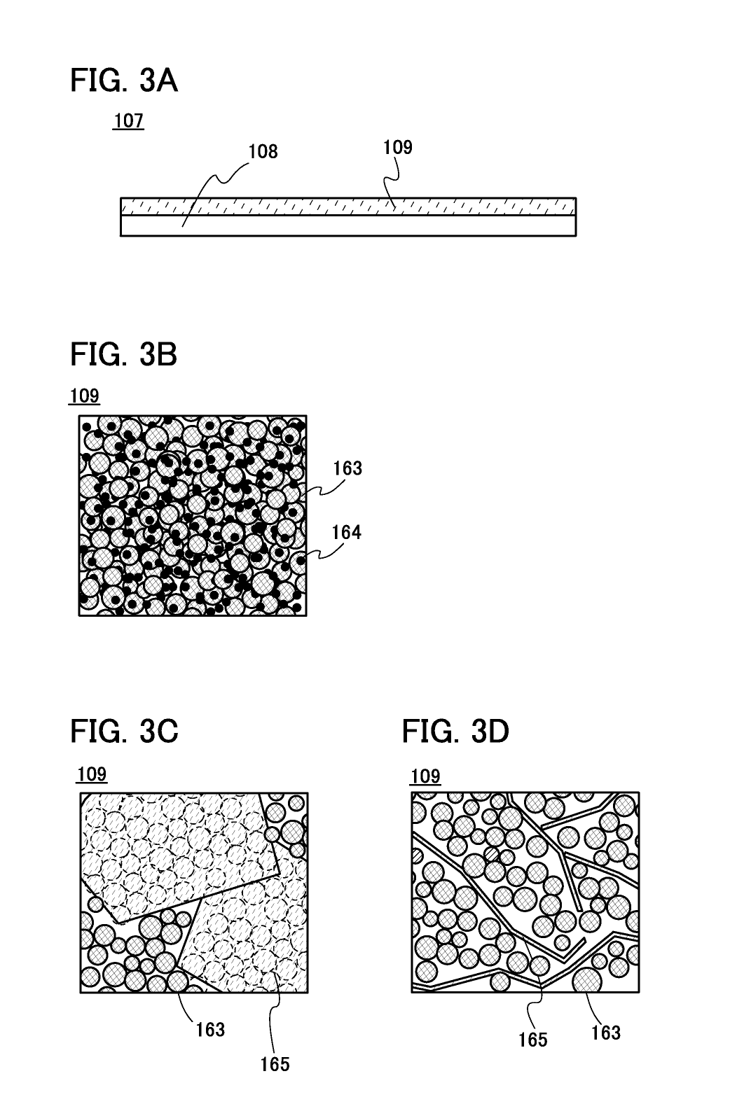

FIG. 3A is a cross-sectional view of the negative electrode 107. The negative electrode 107 includes the negative electrode current collector 108 and the negative electrode active material layer 109 provided over the negative electrode current collector 108.

The negative electrode current collector 108 is formed using a highly conductive material which is not alloyed with a carrier ion such as lithium. For example, stainless steel, iron, copper, nickel, or titanium can be used. In addition, the negative electrode current collector 108 can have a foil-like shape, a plate-like shape (sheet-like shape), a net-like shape, a punching-metal shape, an expanded-metal shape, or the like as appropriate. The negative electrode current collector 108 preferably has a thickness of more than or equal to 10 μm and less than or equal to 30 μm.

There is no particular limitation on a material of the negative electrode active material layer 109 as long as the material can occlude and release carrier ions. For example, a lithium metal, a carbon-based material, silicon, a silicon alloy, or tin can be used. As a carbon-based material which can occlude and release lithium ions, an amorphous or crystalline carbon material such as a graphite powder or a graphite fiber can be used.

The negative electrode active material layer 109 is described with reference to FIG. 3B. A cross section of a portion of the negative electrode active material layer 109 is illustrated in FIG. 3B. The negative electrode active material layer 109 includes a particulate negative electrode active material 163, a conductive additive 164, and a binder (not illustrated). Particles of the particulate negative electrode active material 163 have an inorganic compound film on part of their surfaces.

The conductive additive 164 increases the conductivity between particles of the negative electrode active material 163 or between the negative electrode active material 163 and the negative electrode current collector 108, and is preferably added to the negative electrode active material layer 109. A material with a large specific surface is desirably used as the conductive additive 164, and acetylene black (AB) or the like is preferably used. Alternatively, a carbon material such as a carbon nanotube, fullerene, graphene, or layers of graphene can be used. Note that the case of using graphene is described later as an example.

As the binder, a material which at least binds the negative electrode active material, the conductive additive, and the current collector is used. Examples of the binder include resin materials such as poly(vinylidene fluoride), a vinylidene fluoride-hexafluoropropylene copolymer, a vinylidene fluoride-tetrafluoroethylene copolymer, styrene-butadiene copolymer rubber, polytetrafluoroethylene, polypropylene, polyethylene, polyamide, and polyimide.

The negative electrode 107 is formed in the following manner. First, the particulate negative electrode active material formed using any of the above-described materials is mixed into a solvent such as NMP (N-methylpyrrolidone) in which a vinylidene fluoride-based polymer such as poly(vinylidene fluoride) or the like is dissolved to form a slurry.

Then, the slurry is applied onto the negative electrode current collector 108 and dried, so that the negative electrode active material layer 109 is formed. After that, rolling with a roller press machine is performed, whereby the negative electrode 107 is formed.

Next, an example in which graphene is used as a conductive additive added to the negative electrode active material layer 109 is described with reference to FIGS. 3C and 3D.

FIG. 3C is a plan view of part of the negative electrode active material layer 109 formed using graphene. The negative electrode active material layer 109 includes the particles of the negative electrode active material 163 having the inorganic compound film on part of their surfaces and graphenes 165 which cover a plurality of particles of the negative electrode active material 163 and surround a plurality of particles of the negative electrode active material 163. In addition, the negative electrode active material layer 109 includes the particles of the negative electrode active material having the inorganic compound film on part of their surfaces and the film (not illustrated) which is in contact with an exposed portion of the negative electrode active material, the inorganic compound film, and the graphene. The binder which is not illustrated may be added. However, the binder is not necessarily added in the case where the graphenes 165 are contained so that they are bound to each other to be fully functional as a binder. The plurality of graphenes 165 cover surfaces of the plurality of particles of the negative electrode active material layer 109 in the negative electrode active material layer 109 in the plan view. The negative electrode active material 163 may be partly exposed.

FIG. 3D is a cross-sectional view of part of the negative electrode active material layer 109 in FIG. 3C. Illustrated in FIG. 3D are the negative electrode active material 163 and the graphenes 165 which cover the plurality of particles of the negative electrode active material 163 in the plan view of the negative electrode active material layer 109. The graphenes 165 are observed to have linear shapes in the cross-sectional view. One graphene or a plurality of graphenes overlap with a plurality of particles of the negative electrode active material 163, or the plurality of particles of the negative electrode active material 163 exists between parts of one graphene or between a plurality of graphenes. Note that the graphenes 165 have a bag-like shape and the plurality of particles of the negative electrode active material exists in the bag-like portion in some cases. The graphenes 165 partly have openings where the particles of the negative electrode active material 163 are exposed in some cases.

The desired thickness of the negative electrode active material layer 109 is determined in the range of 20 μm to 150 μm.

Note that the negative electrode active material layer 109 may be predoped with lithium. Predoping with lithium may be performed in such a manner that a lithium layer is formed on a surface of the negative electrode active material layer 109 by a sputtering method. Alternatively, lithium foil may be provided on the surface of the negative electrode active material layer 109, whereby the negative electrode active material layer 109 can be predoped with lithium.

As an example of the negative electrode active material 163, there is a material whose volume is increased by occlusion of carrier ions. Thus, the negative electrode active material layer containing such a material gets friable and is partly broken due to charge and discharge, which reduces the reliability (e.g., cycle performance) of the power storage device. However, even when the volume of the negative electrode active material increases due to charge and discharge, the graphenes can prevent dispersion of the particles of the negative electrode active material and the breakdown of the negative electrode active material layer because the graphenes cover the periphery of the negative electrode active material. That is to say, the graphenes have a function of maintaining the bond between the particles of the negative electrode active material even when the volume of the negative electrode active material fluctuates due to charge and discharge.

That is, a binder does not have to be used in forming the negative electrode active material layer 109. Accordingly, the proportion of the negative electrode active material in the negative electrode active material layer 109 with certain weight (certain volume) can be increased, leading to an increase in charge/discharge capacity per unit weight (unit volume) of the electrode.

The graphenes 165 have conductivity and are in contact with a plurality of particles of the negative electrode active material 163; thus, they also serve as a conductive additive. That is, a conductive additive does not have to be used in forming the negative electrode active material layer 109. Accordingly, the proportion of the negative electrode active material in the negative electrode active material layer 109 with certain weight (certain volume) can be increased, leading to an increase in charge/discharge capacity per unit weight (unit volume) of the electrode.

Further, the graphene 165 efficiently forms a sufficient conductive path of electrons in the negative electrode active material layer 109, which increases the conductivity of the negative electrode for a power storage device.

Note that the graphenes 165 also function as a negative electrode active material that can occlude and release carrier ions, leading to an increase in discharge capacity of the negative electrode for a power storage device which is formed later.

Next, a method for forming the negative electrode active material layer 109 in FIGS. 3C and 3D is described.

First, the particles of the negative electrode active material 163 and a dispersion liquid containing graphene oxide are mixed to form the slurry.

Then, the slurry is applied to the negative electrode current collector 108. Next, drying is performed in a vacuum for a certain period of time to remove a solvent from the slurry applied to the negative electrode current collector 108. After that, rolling with a roller press machine is performed.

Then, the graphene oxide is electrochemically reduced with electric energy or thermally reduced by heat treatment to form the graphenes 165. Particularly when electrochemical reduction treatment is performed, the proportion of formed C(π)-C(π) double bonds in graphene is high as compared with that in graphene formed by heat treatment; therefore, the graphenes 165 can have high conductivity. Through the above process, the negative electrode active material layer 109 including graphenes as a conductive additive can be formed over the negative electrode current collector 108, whereby the negative electrode 107 can be formed.

Through the above steps, the negative electrode active material layer 109 in which the graphenes are used as a conductive additive can be formed over the negative electrode current collector 108, and thus the negative electrode 107 can be formed.

The positive electrode 104, the negative electrode 107, and the separator 110 are soaked in an ionic liquid that is an electrolyte solution. As illustrated in FIG. 1B, the positive electrode 104, the separator 110, the negative electrode 107, and the negative electrode can 102 are stacked in this order with the positive electrode can 101 that is covered with the protective component 111 positioned at the bottom, and then the positive electrode can 101 and the negative electrode can 102 are subjected to pressure bonding with the gasket 103 provided therebetween. Alternatively, in the case where the protective component 111 and the positive electrode can 101 are separated from each other, the protective component 111, the positive electrode 104, the separator 110, the negative electrode 107, and the negative electrode can 102 are stacked in this order with the positive electrode can 101 positioned at the bottom, and then the positive electrode can 101 and the negative electrode can 102 are subjected to pressure bonding with the gasket 103 provided therebetween. In this manner, the coin-type power storage device 100 with a high degree of safety and improved cycle life, in which elution of the positive electrode current collector 105 in the ionic liquid can be prevented, can be manufactured.

### Embodiment 2

A structure of a power storage device of one embodiment of the present invention will be described with reference to the drawings. An example in which the power storage device is a lithium-ion secondary battery will be described below.

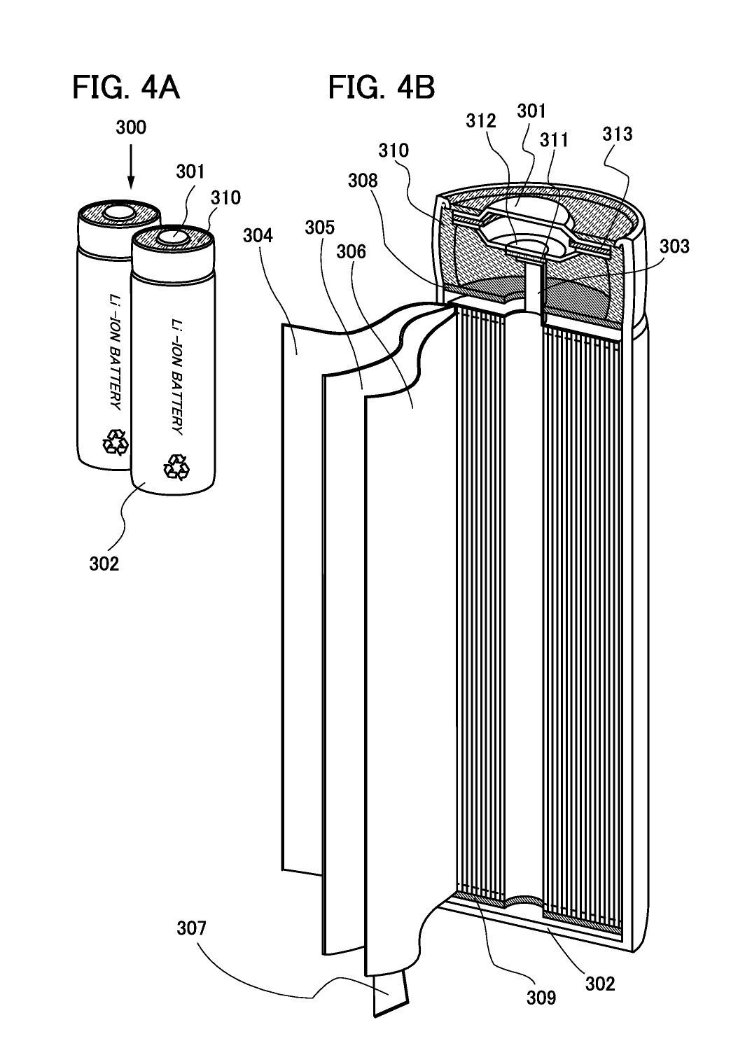

An example of a cylindrical power storage device will be described with reference to FIGS. 4A and 4B. As illustrated in FIG. 4A, a cylindrical power storage device 300 includes a positive electrode cap (also referred to as battery cap) 301, which is part of an exterior body, on the top surface and a battery can 302, which is part of the exterior body, on the side surface and bottom surface. The positive electrode cap 301 and the battery can 302 are insulated from each other by a gasket (also referred to as insulating gasket) 310.

FIG. 4B is a diagram schematically illustrating a cross section of the cylindrical power storage device. Inside the battery can 302 having a hollow cylindrical shape, a battery element in which a strip-shaped positive electrode 304 and a strip-shaped negative electrode 306 are wound with a strip-shaped separator 305 interposed therebetween is provided. Although not illustrated, the battery element is wound around a center pin. One end of the battery can 302 is close and the other end thereof is open. For the battery can 302, a metal having a corrosion-resistant property to a liquid such as an electrolyte solution in charging and discharging a secondary battery, such as nickel, aluminum, or titanium; an alloy of any of the metals; an alloy containing any of the metals and another metal (e.g., stainless steel); a stack of any of the metals; a stack including any of the metals and any of the alloys (e.g., a stack of stainless steel and aluminum); or a stack including any of the metals and another metal (e.g., a stack of nickel, iron, and nickel) can be used. Inside the battery can 302, the battery element in which the positive electrode, the negative electrode, and the separator are wound is interposed between a pair of insulating plates 308 and 309 which face each other. Further, an electrolyte solution (not illustrated) is injected inside the battery can 302 provided with the battery element. When the power storage device is placed upside down or when the electrolyte solution is injected, a positive electrode terminal 303 or a safety valve mechanism 312 may be soaked in the electrolyte solution. As the electrolyte solution, an electrolyte solution which is similar to those of the above coin-type power storage device can be used.

Although the positive electrode 304 and the negative electrode 306 can be formed in a manner similar to that of the positive electrode and the negative electrode of the coin-type power storage device described above, the difference lies in that, since the positive electrode and the negative electrode of the cylindrical power storage device are wound, active materials are formed on both sides of the current collectors. A positive electrode terminal 303, which is part of a positive electrode current collector and also referred to as positive electrode current collecting lead, is connected to the positive electrode 304, and a negative electrode terminal 307, which is part of a negative electrode current collector and also referred to as negative electrode current collecting lead, is connected to the negative electrode 306. Both the positive electrode terminal 303 and the negative electrode terminal 307 can be formed using a metal material such as aluminum. The positive electrode terminal 303 and the negative electrode terminal 307 are resistance-welded to a safety valve mechanism 312 and the bottom of the battery can 302, respectively. The positive electrode cap 301 and the safety valve mechanism 312 can be both formed using stainless steel. A plate-shaped protective component 311 is provided between the safety valve mechanism 312 and the positive electrode terminal 303. The safety valve mechanism 312 is electrically connected to the positive electrode cap 301 through a positive temperature coefficient (PTC) element 313. The safety valve mechanism 312 cuts off electrical connection between the positive electrode cap 301 and the positive electrode 304 when the internal pressure of the battery exceeds a predetermined threshold value. Further, the PTC element 313, which serves as a thermally sensitive resistor whose resistance increases as temperature rises, limits the amount of current by increasing the resistance, in order to prevent abnormal heat generation. Note that barium titanate (BaTiO₃)-based semiconductor ceramic or the like can be used for the PTC element.

Note that in this embodiment, the cylindrical power storage device is given as an example of the power storage device; however, any of power storage devices with a variety of shapes, such as a sealed power storage device and a square-type power storage device, can be used. Further, a structure in which a plurality of positive electrodes, a plurality of negative electrodes, and a plurality of separators are stacked or wound may be employed.

An ionic liquid is used as the electrolyte solution in the power storage device 300 described in this embodiment. The protective component is provided between the positive electrode terminal and the safety valve mechanism that is electrically connected to the positive electrode cap serving as part of an exterior body. Therefore, elution of the positive electrode in the ionic liquid can be prevented, and a power storage device with a high degree of safety and improved cycle life can be manufactured.

With one embodiment of the present invention, a high-performance power storage device can be provided. Note that this embodiment can be implemented in combination with any of the other embodiments, as appropriate.

### Embodiment 3

In this embodiment, a power storage device having a structure different from those of the power storage devices described in the above embodiment will be described. Specifically, descriptions will be given taking a lithium-ion capacitor and an electric double layer capacitor (EDLC) as examples.

A lithium-ion capacitor is a hybrid capacitor having a combination of a positive electrode of an electric double layer capacitor and a negative electrode of a lithium-ion secondary battery formed using a carbon material and is also an asymmetric capacitor where power storage principles of the positive electrode and the negative electrode are different from each other. The positive electrode forms an electrical double layer and enables charge and discharge by a physical action, whereas the negative electrode enables charge and discharge by a chemical action of lithium. In a lithium-ion capacitor, a negative electrode in which lithium is occluded in a negative electrode active material such as a carbon material is used, whereby energy density is much higher than that of a conventional electric double layer capacitor whose negative electrode is formed using active carbon.

In a lithium-ion capacitor, instead of the positive electrode active material layer in the power storage device described in the above embodiments, a material capable of reversibly having at least one of lithium ions and anions is used. Examples of such a material are active carbon, a conductive polymer, and a polyacenic semiconductor (PAS).

The lithium-ion capacitor has high charge and discharge efficiency which allows rapid charge and discharge and has a long life even when it is repeatedly used.

The use of an ionic liquid as an electrolytic solution in the lithium-ion capacitor allows the lithium-ion capacitor to operate at a wide range of temperatures including low temperatures. Further, in the lithium-ion capacitor, degradation of battery characteristics at low temperatures is minimized.

Note that in the case of an electric double layer capacitor, active carbon, a conductive polymer, a polyacene organic semiconductor (PAS), or the like can be used as a positive electrode active material layer and a negative electrode active material layer. An electrolytic solution in the electric double layer capacitor can be formed of only an ionic liquid without using a salt, in which case, the electric double layer capacitor can operate at a wide range of temperatures including low temperatures. Further, in the electric double layer capacitor, degradation of battery characteristics at low temperatures is minimized.

With one embodiment of the present invention, a high-performance power storage device can be provided. Note that this embodiment can be implemented in combination with any of the structures described in the other embodiments, as appropriate.

### Embodiment 4

The power storage device of one embodiment of the present invention can be used for power supplies of a variety of electric appliances which can be operated with power.

Specific examples of electric appliances each utilizing the power storage device of one embodiment of the present invention are as follows: display devices, lighting devices, desktop personal computers and laptop personal computers, image reproduction devices which reproduce still images and moving images stored in recording media such as Blu-ray Discs, mobile phones, smartphones, portable information terminals, portable game machines, e-book readers, video cameras, digital still cameras, high-frequency heating appliances such as microwave ovens, electric rice cookers, electric washing machines, air-conditioning systems such as air conditioners, electric refrigerators, electric freezers, electric refrigerator-freezers, freezers for preserving DNA, and dialyzers. In addition, moving objects driven by electric motors using power from power storage devices are also included in the category of electric appliances. Examples of the moving objects include electric vehicles, hybrid vehicles each including both an internal-combustion engine and an electric motor, and motorized bicycles including motor-assisted bicycles.

In the electric appliances, the power storage device of one embodiment of the present invention can be used as a power storage device for supplying enough power for almost the whole power consumption (referred to as a main power supply). Alternatively, in the electric appliances, the power storage device of one embodiment of the present invention can be used as a power storage device which can supply power to the electric appliances when the supply of power from the main power supply or a commercial power supply is stopped (such a power storage device is referred to as an uninterruptible power supply). Still alternatively, in the electric appliances, the power storage device of one embodiment of the present invention can be used as a power storage device for supplying power to the electric appliances at the same time as the power supply from the main power supply or a commercial power supply (such a power storage device is referred to as an auxiliary power supply).

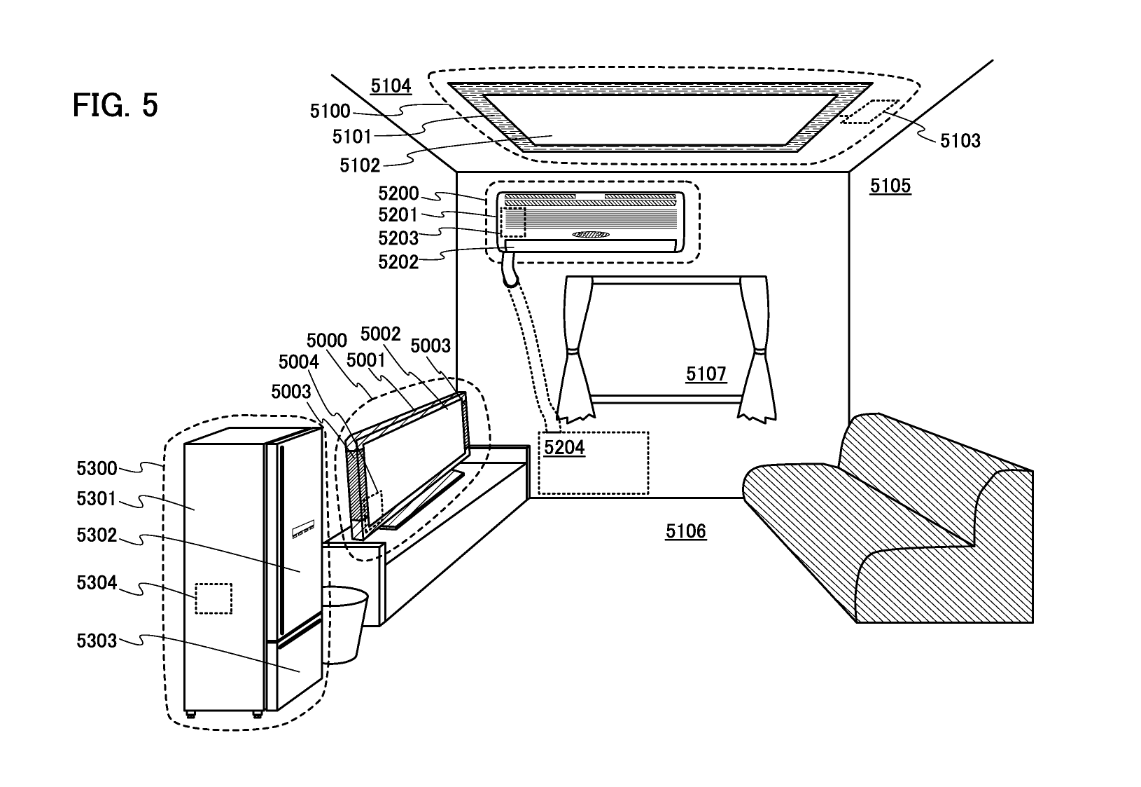

FIG. 5 illustrates specific structures of the electric appliances. In FIG. 5, a display device 5000 is an example of an electric appliance including a power storage device 5004. Specifically, the display device 5000 corresponds to a display device for TV broadcast reception and includes a housing 5001, a display portion 5002, speaker portions 5003, and the power storage device 5004. The power storage device 5004 of one embodiment of the present invention is provided in the housing 5001. The display device 5000 can receive electric power from a commercial power supply. Alternatively, the display device 5000 can use electric power stored in the power storage device 5004. Thus, the display device 5000 can be operated with the use of the power storage device 5004 as an uninterruptible power supply even when electric power cannot be supplied from a commercial power supply due to power failure or the like.

A semiconductor display device such as a liquid crystal display device, a light-emitting device in which a light-emitting element such as an organic EL element is provided in each pixel, an electrophoresis display device, a digital micromirror device (DMD), a plasma display panel (PDP), or a field emission display (FED) can be used for the display portion 5002.

Note that the display device includes, in its category, all of information display devices for personal computers, advertisement displays, and the like besides TV broadcast reception.

In FIG. 5, an installation lighting device 5100 is an example of an electric appliance including a power storage device 5103. Specifically, the lighting device 5100 includes a housing 5101, a light source 5102, and a power storage device 5103. Although FIG. 5 illustrates the case where the power storage device 5103 is provided in a ceiling 5104 on which the housing 5101 and the light source 5102 are installed, the power storage device 5103 may be provided in the housing 5101. The lighting device 5100 can receive electric power from a commercial power supply. Alternatively, the lighting device 5100 can use electric power stored in the power storage device 5103. Thus, the lighting device 5100 can be operated with the use of the power storage device 5103 as an uninterruptible power supply even when electric power cannot be supplied from a commercial power supply due to power failure or the like.

Note that although the installation lighting device 5100 provided in the ceiling 5104 is illustrated in FIG. 5 as an example, the power storage device of one embodiment of the present invention can be used in an installation lighting device provided in, for example, a wall 5105, a floor 5106, a window 5107, or the like other than the ceiling 5104. Alternatively, the power storage device can be used in a tabletop lighting device or the like.

As the light source 5102, an artificial light source which emits light artificially by using electric power can be used. Specifically, an incandescent lamp, a discharge lamp such as a fluorescent lamp, and light-emitting elements such as an LED and an organic EL element are given as examples of the artificial light source.

In FIG. 5, an air conditioner including an indoor unit 5200 and an outdoor unit 5204 is an example of an electric appliance including a power storage device 5203. Specifically, the indoor unit 5200 includes a housing 5201, an air outlet 5202, and a power storage device 5203. Although FIG. 5 illustrates the case where the power storage device 5203 is provided in the indoor unit 5200, the power storage device 5203 may be provided in the outdoor unit 5204. Alternatively, the power storage devices 5203 may be provided in both the indoor unit 5200 and the outdoor unit 5204. The air conditioner can receive electric power from a commercial power supply. Alternatively, the air conditioner can use electric power stored in the power storage device 5203. Particularly in the case where the power storage devices 5203 are provided in both the indoor unit 5200 and the outdoor unit 5204, the air conditioner can be operated with the use of the power storage device 5203 of one embodiment of the present invention as an uninterruptible power supply even when electric power cannot be supplied from a commercial power supply due to power failure or the like.

Note that although the split-type air conditioner including the indoor unit and the outdoor unit is illustrated in FIG. 5 as an example, the power storage device of one embodiment of the present invention can be used in an air conditioner in which the functions of an indoor unit and an outdoor unit are integrated in one housing.

In FIG. 5, an electric refrigerator-freezer 5300 is an example of an electric appliance including a power storage device 5304. Specifically, the electric refrigerator-freezer 5300 includes a housing 5301, a door for a refrigerator 5302, a door for a freezer 5303, and the power storage device 5304. The power storage device 5304 is provided in the housing 5301 in FIG. 5. The electric refrigerator-freezer 5300 can receive electric power from a commercial power supply. Alternatively, the electric refrigerator-freezer 5300 can use electric power stored in the power storage device 5304. Thus, the electric refrigerator-freezer 5300 can be operated with the use of the power storage device 5304 as an uninterruptible power supply even when electric power cannot be supplied from a commercial power supply due to power failure or the like.

Note that among the electric appliance described above, a high-frequency heating apparatus such as a microwave oven and an electric appliance such as an electric rice cooker require high power in a short time. The excess of electric power over a prescribed electric amount of a commercial power supply can be prevented in use of an electric appliance by using the power storage device of one embodiment of the present invention as an auxiliary power supply for supplying electric power which cannot be supplied enough by the commercial power supply.

In addition, in a time period when electric appliances are not used, particularly when the proportion of the amount of electric power which is actually used to the total amount of electric power which can be supplied from a commercial power supply source (such a proportion referred to as a usage rate of electric power) is low, electric power can be stored in the power storage device, whereby the usage rate of electric power can be reduced in a time period when the electric appliances are used. For example, in the case of the electric refrigerator-freezer 5300, electric power can be stored in the power storage device 5304 in night time when the temperature is low and the door for a refrigerator 5302 and the door for a freezer 5303 are not often opened or closed. On the other hand, in daytime when the temperature is high and the door for a refrigerator 5302 and the door for a freezer 5303 are frequently opened and closed, the power storage device 5304 is used as an auxiliary power supply; thus, the usage rate of electric power in daytime can be reduced.

Note that this embodiment can be implemented in combination with any of the structures described in the other embodiments, as appropriate.

### Embodiment 5

Next, a portable information terminal which is an example of electric appliances provided with the power storage device of one embodiment of the present invention will be described.

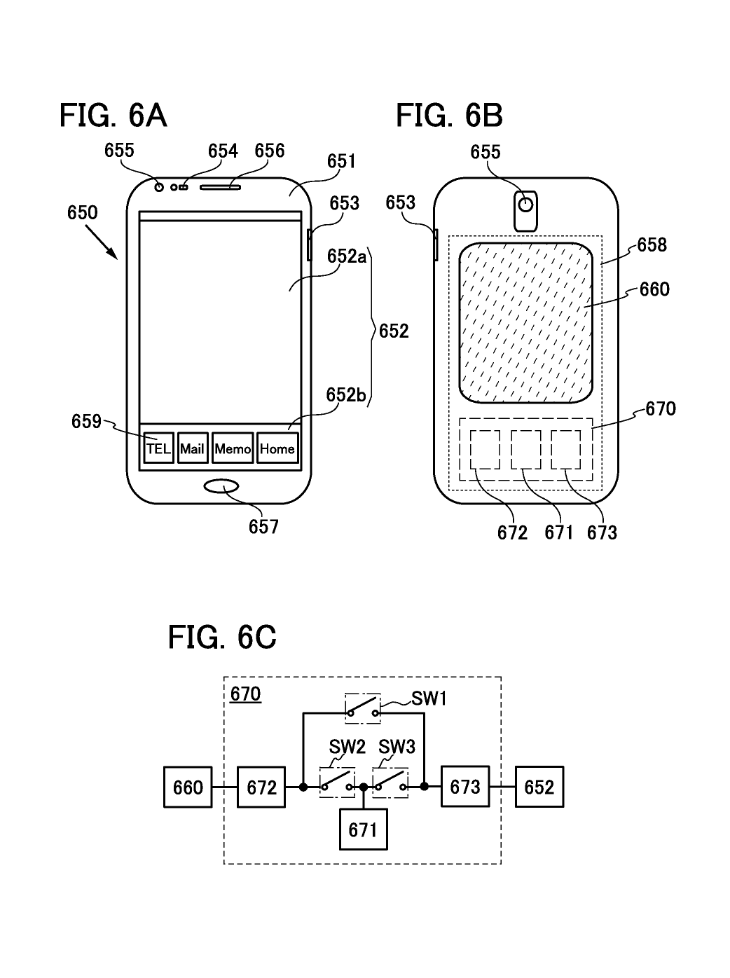

FIG. 6A is a schematic diagram of the front side of a portable information terminal 650. FIG. 6B is a schematic diagram of the back side of the portable information terminal 650. The portable information terminal 650 includes a housing 651, display portions 652 (including a display portion 652a and a display portion 652b), a power button 653, an optical sensor 654, a camera lens 655, a speaker 656, a microphone 657, and a power source 658.

The display portion 652a and the display portion 652b are touch panels. In the display portion 652a and the display portion 652b, keyboard buttons for inputting text can be displayed as needed. When the keyboard button is touched with a finger, a stylus, or the like, text can be input. Alternatively, when text is directly written or an illustration is directly drawn in the display portion 652a with a finger, a stylus, or the like without displaying the keyboard buttons, the text or the illustration can be displayed.

In the display portion 652b, functions which can be performed by the portable information terminal 650 are displayed. When a marker indicating a desired function is touched with a finger, a stylus, or the like, the portable information terminal 650 performs the function. For example, when a marker 659 is touched, the portable information terminal 650 can function as a phone; thus, phone conversation with the speaker 656 and the microphone 657 is possible.

The portable information terminal 650 incorporates a detecting device for determining inclination, such as a gyroscope or an acceleration sensor (not illustrated). Thus, when the housing 651 is placed horizontally or vertically, switching between display directions, for example, switching between a landscape mode and a portrait mode can be performed in the display portion 652a and the display portion 652b.

Further, the portable information terminal 650 is provided with the optical sensor 654; thus, in the portable information terminal 650, the brightness of the display portion 652a and the display portion 652b can be optimally controlled in accordance with the amount of ambient light detected with the optical sensor 654.

The portable information terminal 650 is provided with the power source 658 including a solar cell 660 and a charge/discharge control circuit 670. FIG. 6C illustrates an example where the charge/discharge control circuit 670 includes a battery 671, a DC-DC converter 672, and a converter 673. The power storage device described in the above embodiment is used as the battery 671.

The portable information terminal 650 can also have a function of displaying various kinds of data (e.g., a still image, a moving image, and a text image), a function of displaying a calendar, a date, the time, or the like on the display portion, a touch-input function of operating or editing data displayed on the display portion by touch input, a function of controlling processing by various kinds of software (programs), and the like.

The solar cell 660, which is attached to the portable information terminal 650, can supply electric power to a display portion, an image signal processor, and the like. Note that the solar cell 660 can be provided on one or both surfaces of the housing 651 and thus the battery 671 can be charged efficiently. The use of the power storage device of one embodiment of the present invention as the battery 671 has advantages such as a reduction in size.

The structure and operation of the charge/discharge control circuit 670 illustrated in FIG. 6B will be described with reference to a block diagram of FIG. 6C. FIG. 6C illustrates the solar cell 660, the battery 671, the DC-DC converter 672, a converter 673, switches SW1 to SW3, and the display portion 652. The battery 671, the DC-DC converter 672, the converter 673, and the switches SW1 to SW3 correspond to the charge and discharge control circuit 670 in FIG. 6B.

First, an example of operation in the case where electric power is generated by the solar cell 660 using external light will be described. The voltage of electric power generated by the solar cell 660 is raised or lowered by the DC-DC converter 672 so that the electric power has a voltage for charging the battery 671. When the display portion 652 is operated with the electric power from the solar cell 660, the switch SW1 is turned on and the voltage of the electric power is raised or lowered by the converter 673 to a voltage needed for operating the display portion 652. In addition, when display on the display portion 652 is not performed, the switch SW1 is turned off and the switch SW2 is turned on so that the battery 671 may be charged.

Although the solar cell 660 is described as an example of a power generation means, there is no particular limitation on the power generation means, and the battery 671 may be charged with any of the other means such as a piezoelectric element or a thermoelectric conversion element (Peltier element). For example, the battery 671 may be charged with a non-contact power transmission module capable of performing charging by transmitting and receiving electric power wirelessly (without contact), or any of the other charge means used in combination.

Note that it is needless to say that one embodiment of the present invention is not limited to the portable information terminal illustrated in FIGS. 6A to 6C as long as the power storage device described in any of the above embodiments is included. Note that this embodiment can be implemented in combination with any of the structures described in the other embodiments, as appropriate.

### Embodiment 6

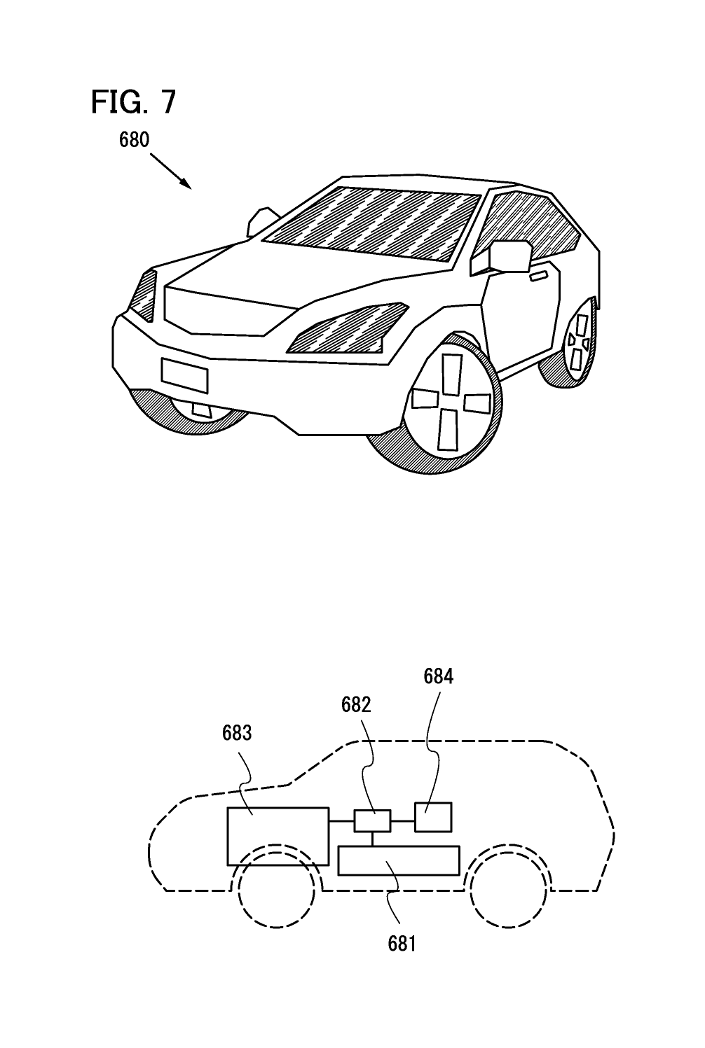

Further, an example of the moving object which is an example of the electric appliance is described with reference to FIG. 7.

Any of the power storage devices described in the above embodiments can be used as a control battery. The control battery can be charged by electric power supply from the outside using a plug-in technique or contactless power feeding. Note that in the case where the moving object is an electric railway vehicle, the electric railway vehicle can be charged by electric power supply from an overhead cable or a conductor rail.

FIG. 7 illustrates an example of an electric vehicle. An electric vehicle 680 is equipped with a battery 681. The output of the power of the battery 681 is adjusted by a control circuit 682 and the power is supplied to a driving device 683. The control circuit 682 is controlled by a processing unit 684 including a ROM, a RAM, a CPU, or the like which is not illustrated.

The driving device 683 includes a DC motor or an AC motor either alone or in combination with an internal-combustion engine. The processing unit 684 outputs a control signal to the control circuit 682 based on input data such as data on operation (e.g., acceleration, deceleration, or stop) by a driver of the electric vehicle 680 or data on driving of the electric vehicle 680 (e.g., data on an uphill or a downhill, or data on a load on a driving wheel). The control circuit 682 adjusts the electric energy supplied from the battery 681 in accordance with the control signal of the processing unit 684 to control the output of the driving device 683. In the case where the AC motor is mounted, although not illustrated, an inverter which converts direct current into alternate current is also incorporated.

The battery 681 can be charged by electric power supply from the outside using a plug-in technique. For example, the battery 681 is charged through a power plug from a commercial power source. The battery 681 can be charged by converting external power into DC constant voltage having a predetermined voltage level through a converter such as an AC-DC converter. When the power storage device of one embodiment of the present invention is provided as the battery 681, capacity of the battery 681 can be increased and improved convenience can be realized. When the battery 681 itself can be made compact and lightweight with improved characteristics of the battery 681, the vehicle can be made lightweight, leading to an increase in fuel efficiency.

Note that it is needless to say that one embodiment of the present invention is not limited to the electric vehicle illustrated in FIG. 7 as long as the power storage device described in any of the above embodiments is included. Note that this embodiment can be implemented in combination with any of the structures described in the other embodiments, as appropriate.

### Example 1

In Example 1, comparison results of discharge characteristics of a lithium-ion secondary battery in which a protective component is provided between and in contact with a positive electrode can serving as part of an exterior body and a positive electrode current collector and a lithium-ion secondary battery in which a positive electrode can is directly in contact with a positive electrode current collector are described.

First of all, the lithium-ion secondary batteries fabricated in Example 1 are described with reference to FIGS. 1A and 1B.

The positive electrode 104 has a layered structure of aluminum foil serving as the positive electrode current collector 105 and the positive electrode active material layer 106 with a thickness of approximately 50 μm. As the positive electrode active material layer 106, a mixture in which lithium iron(II) phosphate (LiFePO₄), acetylene black serving as a conductive additive, and poly(vinylidene fluoride) serving as a binder were mixed at a weight ratio of 85:8:7 was formed on one side of the aluminum foil. Note that the amount of LiFePO₄ in the positive electrode 104 was approximately 6.0 mg/cm² and the single-electrode theoretical capacity was approximately 1.0 mAh/cm².

The negative electrode 107 has a layered structure of copper foil serving as the negative electrode current collector 108 and the negative electrode active material layer 109 with a thickness of approximately 100 μm. As the negative electrode active material layer 109, a mixture in which mesocarbon microbeads (MCMB) powder with a diameter of 9 μm, acetylene black serving as a conductive additive, and poly(vinylidene fluoride) serving as a binder were mixed at a weight ratio of 93:2:5 was formed on one side of the copper foil. Note that the amount of MCMB in the negative electrode 107 was approximately 9.3 mg/cm² and the single-electrode theoretical capacity was approximately 3.5 mAh/cm².

As the protective component 111, an aluminum film with such a thickness as to adequately cover the positive electrode can was used.

In an electrolyte solution, P13-FSA represented by the following structural formula was used as a nonaqueous solvent, and lithium bis(trifluoromethylsulfonyl)amide (hereinafter abbreviated to LiTFSA) was used as a lithium salt. A solution formed by dissolving 1M LiTFSA in P13-FSA was used.

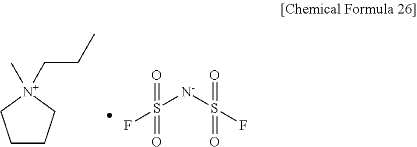

As the separator 110, a poly(vinylidene fluoride) film with a thickness of approximately 125 μm subjected to hydrophilic treatment was used. The separator 110 was impregnated with the above-described electrolyte solution.

The positive electrode can 101 and the negative electrode can 102 were formed using stainless steel (SUS). As the gasket 103, a spacer or a washer was used.

As illustrated in FIGS. 1A and 1B, the positive electrode can 101 coated with the protective component 111, the positive electrode 104, the separator 110, the negative electrode 107, the gasket 103, and the negative electrode can 102 were stacked, and the positive electrode can 101 and the negative electrode can 102 were crimped to each other with a “coin cell crimper”. Thus, the coin-type lithium ion secondary battery was fabricated. The fabricated coin-type lithium ion secondary battery is Sample 1.

Further, a coin-type lithium ion secondary battery of Sample 1 from which the protective component 111 is excluded so that the positive electrode can 101 is directly in contact with the positive electrode current collector 105 is Comparative Example 1. Note that the other structures such as the concentration of the lithium salt in Comparative Example 1 are the same as those of Sample 1 and were fabricated in the same manner as that of Sample 1.

The charge and discharge characteristics of Sample 1 and Comparative Example 1 were measured. The measurement was performed with a charge-discharge measuring instrument (produced by TOYO SYSTEM Co., LTD.) in the state that Sample 1 and Comparative Example 1 were heated and kept at 60° C. Further, charge and discharge in the measurement were performed at a rate of approximately 0.2 C in the voltage range of 2.0 V to 4.0 V (constant current charge and discharge).

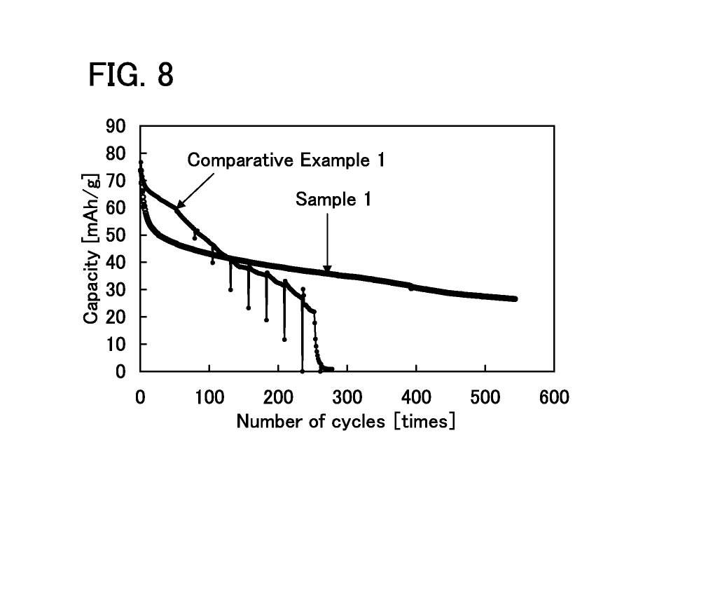

FIG. 8 shows cycle performance of Sample 1 and Comparative Example 1. The vertical axis indicates discharge capacity of the secondary battery (mAh/g), and the horizontal axis indicates the number of cycles (times). The thick line represents the results of Sample 1, and the thin line represents Comparative Example 1.

The measurement results of Comparative Example 1 show that after 250 cycles, the discharge capacity decreases drastically and the degradation is significant.

In contrast, the discharge capacity of the secondary battery of Sample 1 shows a tendency to decrease but does not decrease drastically as compared with the secondary battery of Comparative Example 1 without the protective component. In Sample 1, the degradation is suppressed sufficiently. The degradation was particularly suppressed at an environment temperature of 60° C. Consequently, the cycle performance was able to be improved.

It can be confirmed from the above measurement results that by providing a protective component between and in contact with a positive electrode can and a positive electrode current collector, elution of the positive electrode current collector due to contact between different kinds of metals can be suppressed and accordingly cycle performance of the lithium-ion battery can be improved.

### EXPLANATION OF REFERENCE

100: power storage device, 101: positive electrode can, 102: negative electrode can, 103: gasket, 104: positive electrode, 105: positive electrode current collector, 106: positive electrode active material layer, 107: negative electrode, 108: negative electrode current collector, 109: negative electrode active material layer, 110: separator, 111: protective component, 153: positive electrode active material, 154: graphene, 163: negative electrode active material, 164: conductive additive, 165: graphene, 300: power storage device, 301: positive electrode cap, 302: battery can, 303: positive electrode terminal, 304: positive electrode, 305: separator, 306: negative electrode, 307: negative electrode terminal, 308: insulating plate, 309: insulating plate, 310: gasket, 311: protective component, 312: safety valve mechanism, 313: TPC element, 650: portable information terminal, 651: housing, 652: display portion, 652a: display portion, 652b: display portion, 653: power button, 654: optical sensor, 655: camera lens, 656: speaker, 657: microphone, 658: power source, 659: marker, 660: solar cell, 670: charge and discharge control circuit, 671: battery, 672: DC-DC converter, 673: converter, 680: electric vehicle, 681: battery, 682: control circuit, 683: driving device, 684: processing unit, 5000: display device, 5001: housing, 5002: display portion, 5003: speaker portion, 5004: power storage device, 5100: lighting device, 5101: housing, 5102: light source, 5103: power storage device, 5104: ceiling, 5105: wall, 5106: floor, 5107: window, 5200: indoor unit, 5201: housing, 5202: air outlet, 5203: power storage device, 5204: outdoor unit, 5300: electric refrigerator-freezer, 5301: housing, 5302: door for a refrigerator, 5303: door for a freezer, 5304: power storage device.

This application is based on Japanese Patent Application serial no. 2012-223622 filed with Japan Patent Office on Oct. 5, 2012, the entire contents of which are hereby incorporated by reference.

1. A power storage device comprising:
a positive electrode and a negative electrode facing each other in an exterior body;
an electrolyte solution between the positive electrode and the negative electrode; and
a protective component having conductivity between the exterior body and the positive electrode,
wherein the electrolyte solution includes an ionic liquid as a solvent.

2. The power storage device according to claim 1, wherein the protective component includes aluminum.

3. The power storage device according to claim 1, wherein the exterior body includes iron or nickel.

4. The power storage device according to claim 1,
wherein the positive electrode includes a current collector, and
wherein the protective component is in contact with the current collector and the exterior body.

5. The power storage device according to claim 4, wherein the current collector includes aluminum.

6. The power storage device according to claim 1, wherein the ionic liquid includes any one of a heterocyclic cation, an aromatic cation, a quaternary ammonium cation, a quaternary sulfonium cation, a quaternary phosphonium cation, a tertiary sulfonium cation, an acyclic quaternary ammonium cation, and an acyclic quaternary phosphonium cation.

7. The power storage device according to claim 1, wherein the ionic liquid includes any one of a monovalent amide anion, a monovalent methide anion, a fluorosulfonic acid anion (SO₃F⁻), a perfluoroalkyl sulfonic acid anion, tetrafluoroborate (BF₄⁻), perfluoroalkylborate, hexafluorophosphate (PF6⁻), and perfluoroalkylphosphate.

8. A power storage device comprising:
a positive electrode and a negative electrode facing each other in an exterior body, the positive electrode including a current collector;
an electrolyte solution between the positive electrode and the negative electrode; and
a protective component having conductivity between the exterior body and the current collector,
wherein a part of the exterior body serves as a positive electrode terminal,
wherein the part of the exterior body is electrically connected to the current collector through the protective component, and
wherein the electrolyte solution includes an ionic liquid as a solvent.

9. The power storage device according to claim 8, wherein the protective component includes aluminum.

10. The power storage device according to claim 8, wherein the exterior body includes iron or nickel.

11. The power storage device according to claim 8, wherein the current collector includes aluminum.

12. The power storage device according to claim 8, wherein the ionic liquid includes any one of a heterocyclic cation, an aromatic cation, a quaternary ammonium cation, a quaternary sulfonium cation, a quaternary phosphonium cation, a tertiary sulfonium cation, an acyclic quaternary ammonium cation, and an acyclic quaternary phosphonium cation.

13. The power storage device according to claim 8, wherein the ionic liquid includes any one of a monovalent amide anion, a monovalent methide anion, a fluorosulfonic acid anion (SO₃F⁻), a perfluoroalkyl sulfonic acid anion, tetrafluoroborate (BF₄⁻), perfluoroalkylborate, hexafluorophosphate (PF6⁻), and perfluoroalkylphosphate.

14. A power storage device comprising:
a positive electrode and a negative electrode facing each other in an exterior body, the positive electrode includes a current collector;
an electrolyte solution between the positive electrode and the negative electrode;
a positive electrode terminal connected to the current collector; and
a protective component having conductivity between the exterior body and the positive electrode terminal,
wherein the electrolyte solution includes an ionic liquid as a solvent.

15. The power storage device according to claim 14, wherein the protective component includes aluminum.

16. The power storage device according to claim 14, wherein the exterior body includes iron or nickel.

17. The power storage device according to claim 14, wherein the current collector includes aluminum.

18. The power storage device according to claim 14, wherein the ionic liquid includes any one of a heterocyclic cation, an aromatic cation, a quaternary ammonium cation, a quaternary sulfonium cation, a quaternary phosphonium cation, a tertiary sulfonium cation, an acyclic quaternary ammonium cation, and an acyclic quaternary phosphonium cation.

19. The power storage device according to claim 14, wherein the ionic liquid includes any one of a monovalent amide anion, a monovalent methide anion, a fluorosulfonic acid anion (SO₃F⁻), a perfluoroalkyl sulfonic acid anion, tetrafluoroborate (BF₄⁻), perfluoroalkylborate, hexafluorophosphate (PF6⁻), and perfluoroalkylphosphate.
